(19) United States
(12) Patent Application Publication
(10) Pub. No.: US 2014/0200795 A1
(43) Pub. Date: Jul. 17, 2014

(54) ENGINE CONTROL DEVICE OF WORKING MACHINE, AND ENGINE CONTROL METHOD FOR THE SAME

(71) Applicants: Tadashi Kawaguchi, Hiratsuka-shi (JP); Takao Suehiro, Hiratsuka-shi (JP); Kentaro Murakami, Chigasaki-shi (JP); Jun Morinaga, Yokohama-shi (JP)

(72) Inventors: Tadashi Kawaguchi, Hiratsuka-shi (JP); Takao Suehiro, Hiratsuka-shi (JP); Kentaro Murakami, Chigasaki-shi (JP); Jun Morinaga, Yokohama-shi (JP)

(73) Assignee: KOMATSU LTD., Tokyo (JP)

(21) Appl. No.: 13/816,494

(22) PCT Filed: Apr. 17, 2012
(86) PCT No.: PCT/JP2012/060380

§ 371 Date: Feb. 12, 2013

(30) Foreign Application Priority Data
May 18, 2011 (JP) 2011-111387

(51) Int. Cl. F02D 31/00

(52) U.S. Cl. CPC F02D 31/001
USPC 701/110

(57) ABSTRACT

An engine control device is provided including a detection unit for detecting the operating state of a working machine; a no-load maximum speed computation unit for computing a no-load maximum speed being an engine speed to be increased to the maximum upon a load of the working machine being released, based on the operating state; a target matching speed computation unit for computing a target matching speed being an engine speed to be increased upon a load being applied to the working machine, separately from the no-load maximum speed, based on the operating state; a target engine output computation unit for computing target engine output EL that can be outputted to the maximum, based on the operating state; and an engine control unit for controlling the engine speed between the no-load maximum speed and the target matching speed under a restriction of the target engine output.

### FIELD

The present invention relates to an engine control device of a working machine including a construction machine such as an excavator, bulldozer, dump truck, or wheel loader, and an engine control method for the same.

### BACKGROUND

If the operator of a working machine arbitrarily sets a fuel adjustment dial (throttle dial) provided in a cab in engine control of diesel engine used for the working machine (hereinafter referred to as the engine), an engine controller outputs to a fuel injection system a control signal for injecting a fuel injection amount in accordance with the setting into the engine. The engine controller then outputs to the fuel injection system a control signal corresponding to a change in the load of work equipment attached to the working machine to maintain a target engine speed set by the fuel adjustment dial (throttle dial), and adjusts engine speed. Moreover, the engine controller or a pump controller calculates the target absorption torque of a hydraulic pump in accordance with the target engine speed. The target absorption torque is set such that the engine's output horsepower is proportional to the hydraulic pump's absorption horsepower.

A description will be given of normal engine control by referring to FIG. 27. The engine is controlled so as not to exceed an engine output torque line TL including a maximum engine output torque line P1 of the engine and an engine droop line Fe subtracted from a maximum engine speed. If the working machine is an excavator or the like, the engine controller generates a control signal for changing the engine speed in accordance with the operation amount of an operating lever operated for a swing operation of an upper structure and an operation of the work equipment, and the loads of the work equipment and the like. For example, if an operation of excavating the soil and the like in a state where the target engine speed is set to N2, the engine shifts from an engine speed at the time when the engine is performing an idle operation (idle engine speed N1) to a target engine speed N2. At this point, the fuel injection system receives the control signal from the engine controller, and injects a fuel into the engine in accordance with the shift. If the operation of the work equipment is performed, and the load increases, the engine speed shifts such that the engine speed and the engine output torque reach a matching point M1 corresponding to an intersection point of a pump absorption torque line PL and the engine output torque line TL of a variable displacement hydraulic pump (typically, a hydraulic swash plate pump). The engine output reaches at its maximum at a rated point P.

Here, in order to improve fuel efficiency of the engine and pump efficiency of the hydraulic pump, there is an engine control device to provide a target engine operating line (target matching route) ML that passes an area of good specific fuel consumption and provide a matching point of engine output and pump absorption torque on the target matching route ML, as illustrated in FIG. 28. In FIG. 28, curves M represent a specific fuel consumption map of the engine, and as the center (eye (M1)) of the curves M is closer, specific fuel consumption becomes superior. Moreover, a curve J represents an equivalent horsepower curve where horsepower absorbed by the hydraulic pump is equivalent horsepower. Therefore, if the same horsepower is obtained, the specific fuel consumption is superior when matching is performed at a matching point pt2 on the target matching route ML to when matching is performed at a matching point pt1 on the engine droop line Fe. Moreover, the flow rate Q of the hydraulic pump is the product of an engine speed n and pump capacity q (Q=n·q). If the same flow rate of hydraulic oil is obtained, pump efficiency is superior when the engine speed is reduced and the pump capacity is increased.

### CITATION LIST

### Patent Literature

Patent Literature 1: Japanese Laid-open Patent Publication No. 2007-120426

### SUMMARY

### Technical Problem

If the engine is controlled by using the above-mentioned target matching route ML, when matching is performed at the matching point M1 at target matching speed n1 on the target matching route ML, for example, as illustrated in a torque diagram of FIG. 29, an engine speed at no load is determined at a low speed n2 (e.g., in the vicinity of 1100 rpm) restrained by a droop line DL1 passing through the matching point M1. When a load is applied, the engine torque increases along the droop line DL1 to match at the matching point M1. In other words, if the engine output is attempted to match with the pump absorption torque on the target matching route ML, the engine output (target matching point M1) and the engine speed (engine speed n2 at no load) are decided by the droop line DL1 in conjunction.

Here, if a load is applied to work equipment at work such as moving a big rock by a working machine, the engine torque increases along the droop line DL1 illustrated in FIG. 29, and a shift is made to the matching point M1. Here, it is convenient for the work since the work equipment's output is obtained; however, the engine is driven at low engine speeds restrained by the droop line DL1 even immediately after the big rock is finished to be moved and the load is released. A hydraulic pump rotates at this low speed and the swash plate angle of a swash plate of the hydraulic pump does not become larger than a predetermined value (maximum capacity); accordingly, the flow rate of hydraulic oil discharged from the hydraulic pump is not supplied sufficiently to a hydraulic cylinder of the work equipment. Therefore, in such a case, there is a problem that the work equipment cannot respond to the operator's intention to move the work equipment quickly for the work, and an uncomfortable feeling about the operation arises.

As a first measure to solve this problem, as illustrated in a torque diagram of FIG. 30, the engine speed at no load is set at a high engine speed n11 (e.g., in the vicinity of 2050 rpm), and a pump absorption torque line representing the maximum torque that the hydraulic pump can absorb in relation to the engine speed is set as PL1. Consequently, if a load is light, the engine output horsepower matches with the pump absorption horsepower at a matching point M11. Therefore, even if the swash plate angle of the hydraulic pump is arbitrary, the engine speed is high; accordingly, the flow rate of hydraulic oil discharged from the hydraulic pump into the hydraulic cylinder of the work equipment is ensured, and a sufficiency of work equipment speed can be promoted. If a load is subsequently applied to the work equipment, the engine torque increases along a droop line DL2, and matching occurs at a matching point M12 on the same equivalent horsepower curve EL1 as the matching point M1; accordingly, it is possible to obtain the desired output of the work equipment. However, a conceivable problem is that if such control is performed, the engine is driven at a position of low fuel consumption, which deviates from the eye M1 of the specific fuel consumption map illustrated in FIG. 28.

Moreover, as a second measure to solve the above-mentioned problem, it is assumed, as illustrated in the torque diagram of FIG. 30, that the pump absorption torque line is set to PL2, and a matching point M13 is set on the target matching route ML instead of the matching point M12. If a load is applied to the work equipment, the output of the engine matches at the matching point M13 along the droop line DL2 from the matching point M11. In this case, matching occurs at a position near the eye M1 of the specific fuel consumption map; however, the engine is driven with engine output on an equivalent horsepower curve EL2 representing high horsepower. Accordingly, it can be considered that energy is consumed more than necessary, and fuel consumption may be deteriorated if compared with the matching point M1 of low engine speed and low output.

The present invention has been made considering the above, and an object thereof is to provide an engine control device of a working machine realizing both low fuel consumption and improvement in workability, and an engine control method for the same.

### Solution to Problem

According to a first aspect of the present invention in order to solve the above problems and achieve the object, there is provided an engine control device of a working machine, including: a detection means for detecting an operating state of the working machine; a no-load maximum speed computation means for computing a no-load maximum speed being an engine speed to be increased to the maximum upon a load of the working machine being released, based on the operating state; a target matching speed computation means for computing a target matching speed being an engine speed to be increased upon a load being applied, separately from the no-load maximum speed, based on the operating state; a target engine output computation means for computing target engine output that can be outputted to the maximum, based on the operating state; and an engine control means for controlling the engine speed between the no-load maximum speed and the target matching speed under a restriction of the target engine output.

According to a second aspect of the present inventions, there is provided the engine control device of a working machine according to the first aspect, further including: a fluctuation range setting means for presetting a range of fluctuations in engine speed; and a minimum matching speed computation means for setting an engine speed reduced by an engine speed equal to the range of fluctuations from the no-load maximum speed as a minimum speed limit value, and computing a minimum matching speed being an engine speed to be increased at the minimum upon a load being applied, based on the operating state, wherein the engine control means controls the engine speed between the no-load maximum speed and the minimum matching speed under the restriction of the target engine output.

According to a third aspect of the present inventions, there is provided the engine control device of a working machine according to any one of the first or second aspect, wherein the engine control means outputs an engine speed that a lower limit speed offset value is added to the target matching speed as an engine speed command value.

According to a fourth aspect of the present inventions, there is provided the engine control device of a working machine according to any one of the first to third aspects, further including: a variable displacement hydraulic pump; and a capacity detection means for detecting pump capacity of the variable displacement hydraulic pump, wherein the engine control means increases the engine speed upon the pump capacity being equal to a threshold value or more, and outputs an engine speed command value that the engine speed is reduced upon the pump capacity being less than the threshold value.

According to a fifth aspect of the present inventions, there is provided the engine control device of a working machine according to the second aspect, wherein the minimum matching speed computation means increases the minimum matching speed upon a detected value by speed detection means for detecting a speed of a rotating structure of the working machine being close to zero, sets a value that the minimum matching speed is reduced as a minimum speed limit value with increase in the detected value by the speed detection means, and computes the minimum matching speed being an engine speed to be increased at the minimum upon a load being applied to the work equipment, based on the operating state.

According to a sixth aspect of the present inventions, there is provided a method for controlling an engine of a working machine, including: a detection step of detecting an operating state of the working machine; a no-load maximum speed computation step of computing a no-load maximum speed being an engine speed to be increased to the maximum upon a load of the working machine being released, based on the operating state; a target matching speed computation step of computing a target matching speed being an engine speed to be increased upon a load being applied to the working machine, separately from the no-load maximum speed, based on the operating state; a target engine output computation step of computing target engine output that can be outputted to the maximum, based on the operating state; and an engine control step of controlling the engine speed between the no-load maximum speed and the target matching speed under a restriction of the target engine output.

According to a seventh aspect of the present inventions, there is provided the method for controlling an engine of a working machine according to the sixth aspect, further including: a fluctuation range setting step of presetting a range of fluctuations in engine speed; and a minimum matching speed computation step of setting an engine speed reduced by an engine speed equal to the range of fluctuations from the no-load maximum speed as a minimum speed limit value, and computing a minimum matching speed being an engine speed to be increased at the minimum upon a load being applied to the working machine, based on the operating state, wherein the engine control step controls the engine speed between the no-load maximum speed and the minimum matching speed under the restriction of the target engine output.

According to the present invention, it is possible to realize both low fuel consumption and improvement in workability since engine speed is controlled between a no-load maximum speed and a target matching speed under a restriction of a target engine output.

### BRIEF DESCRIPTION OF DRAWINGS

FIG. 1 is a perspective view illustrating the entire configuration of an excavator according to a first embodiment of the present invention.

FIG. 2 is a schematic diagram illustrating the configuration of a control system of the excavator illustrated in FIG. 1.

FIG. 3 is a torque diagram for explaining the contents of engine control by an engine controller or pump controller.

FIG. 4 is a torque diagram for explaining the contents of engine control by the engine controller or pump controller.

FIG. 5 is a view illustrating an entire control flow by the engine controller or pump controller.

FIG. 6 is a view illustrating a detailed control flow of a no-load maximum speed computation block illustrated in FIG. 5.

FIG. 7 is a view illustrating a detailed control flow of a minimum engine output computation block illustrated in FIG. 5.

FIG. 8 is a view illustrating a detailed control flow of a maximum engine output computation block illustrated in FIG. 5.

FIG. 9 is a view illustrating a detailed control flow of a target engine output computation block illustrated in FIG. 5.

FIG. 10 is a view illustrating a detailed control flow of a minimum matching speed computation block illustrated in FIG. 5.

FIG. 11 is a view illustrating a detailed control flow of a target matching speed computation block illustrated in FIG. 5.

FIG. 12 is a view illustrating a detailed control flow of an engine speed command value computation block illustrated in FIG. 5.

FIG. 13 is a view illustrating a detailed control flow of a pump absorption torque command value computation block illustrated in FIG. 5.

FIG. 14 is a torque diagram for explaining the contents of engine control by the engine controller or pump controller.

FIG. 15 is a torque diagram illustrating the state of engine output variations due to pump variations in conventional engine control.

FIG. 16 is a torque diagram illustrating the state of engine output variations due to pump variations in the first embodiment of the present invention.

FIG. 17 is a torque diagram illustrating the state of an engine output shift during a period of transition in conventional engine control.

FIG. 18 is a torque diagram illustrating the state of an engine output shift during a period of transition in the first embodiment of the present invention.

FIG. 19 is a schematic diagram illustrating the configuration of a control system of a hybrid excavator being a second embodiment of the present invention.

FIG. 20 is a view illustrating an entire control flow by an engine controller, pump controller, or hybrid controller of the second embodiment of the present invention.

FIG. 21 is a view illustrating a detailed control flow of a no-load maximum speed computation block illustrated in FIG. 20.

FIG. 22 is a view illustrating a detailed control flow of a maximum engine output computation block illustrated in FIG. 20.

FIG. 23 is a view illustrating a detailed control flow of a minimum matching speed computation block illustrated in FIG. 20.

FIG. 24 is a view illustrating a detailed control flow of a target matching speed computation block illustrated in FIG. 20.

FIG. 25 is a view illustrating a detailed control flow of a pump absorption torque command value computation block illustrated in FIG. 20.

FIG. 26 is a torque diagram illustrating the setting state of a target matching speed at the time of power generation ON/OFF.

FIG. 27 is a torque diagram for explaining conventional engine control.

FIG. 28 is a torque diagram for explaining the conventional engine control using a target matching route.

FIG. 29 is a torque diagram for explaining the conventional engine control.

FIG. 30 is a torque diagram for explaining the conventional engine control.

### DESCRIPTION OF EMBODIMENTS

A description will hereinafter be given of embodiments for carrying out the present invention with reference to the accompanying drawings.

### First Embodiment

### [Entire Configuration]

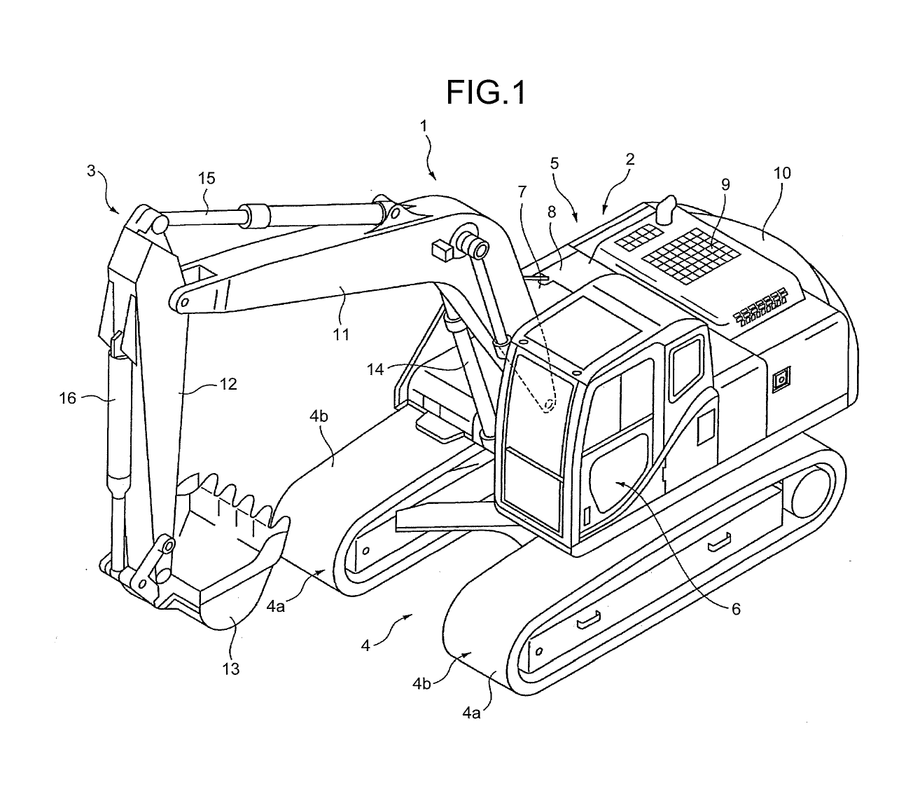

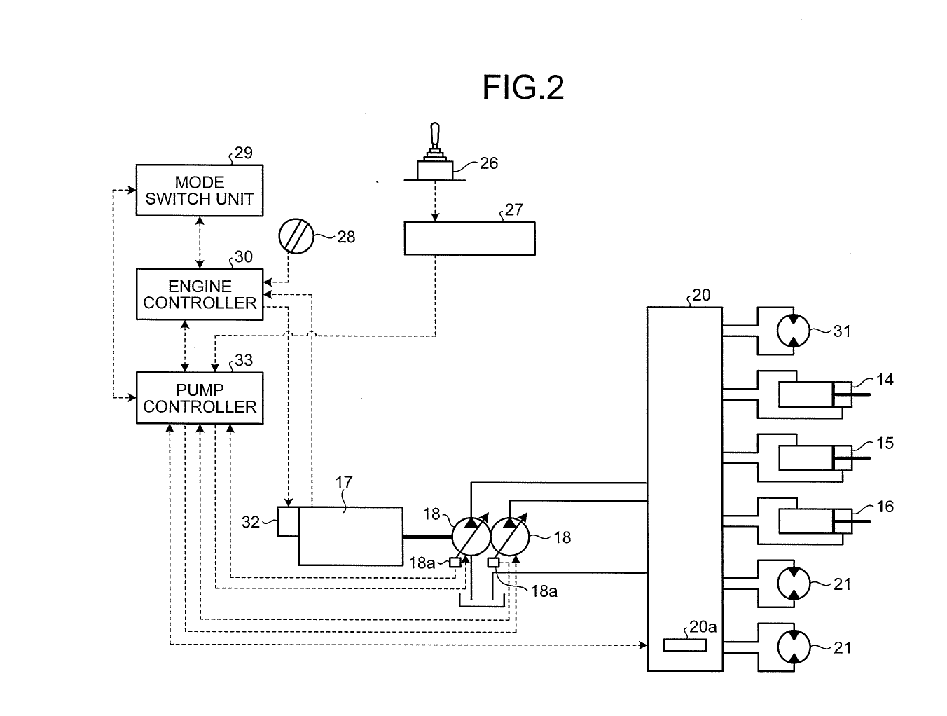

Firstly, FIGS. 1 and 2 illustrate the entire configuration of an excavator 1 being an example of a working machine. The excavator 1 is provided with a vehicle base machine 2 and work equipment 3. The vehicle base machine 2 includes an undercarriage 4 and an upper structure 5. The undercarriage 4 includes a pair of travel devices 4a. The travel devices 4a each include a crawler 4b. The travel devices 4a cause the excavator 1 to travel or swing by driving the crawlers 4b with a right travel motor and a left travel motor (travel motors 21).

The upper structure 5 is provided on the undercarriage 4 in a manner capable of swinging, and swings by the drive of a swing hydraulic motor 31. Moreover, the upper structure 5 is provided with a cab 6. The upper structure 5 includes a fuel tank 7, a hydraulic oil tank 8, an engine room 9, and a counter weight 10. The fuel tank 7 stores a fuel for driving an engine 17. The hydraulic oil tank 8 stores hydraulic oil discharged from a hydraulic pump 18 into hydraulic cylinders such as a boom cylinder 14, and hydraulic devices such as the swing hydraulic motor 31 and the travel motors 21. The engine room 9 houses devices such as the engine 17 and the hydraulic pump 18. The counter weight 10 is disposed at the rear of the engine room 9.

The work equipment 3 is attached to the center front position of the upper structure 5, and includes a boom 11, an arm 12, a bucket 13, the boom cylinder 14, an arm cylinder 15, and a bucket cylinder 16. A base end of the boom 11 is coupled to the upper structure 5 rotatably. Moreover, a distal end of the boom 11 is coupled to a base end of the arm 12 rotatably. A distal end of the arm 12 is coupled to the bucket 13 rotatably. The boom cylinder 14, the arm cylinder 15, and the bucket cylinder 16 are hydraulic cylinders that are driven by hydraulic oil discharged from the hydraulic pump 18. The boom cylinder 14 operates the boom 11. The arm cylinder 15 operates the arm 12. The bucket cylinder 16 operates the bucket 13.

In FIG. 2, the excavator 1 includes the engine 17 and the hydraulic pump 18 as drive sources. A diesel engine is used as the engine 17, and a variable displacement hydraulic pump (e.g., hydraulic swash plate pump) is used as the hydraulic pump 18. An output shaft of the engine 17 is mechanically coupled to the hydraulic pump 18. The hydraulic pump 18 is driven by driving the engine 17.

A hydraulic drive system is driven in accordance with an operation of operation levers 26, such as a work equipment lever, a travel lever, or a swing lever, that is provided in the cab 6 provided to the vehicle base machine 2. The operation amount of the operation lever 26 is converted by a lever operation amount detection unit 27 into an electrical signal. The lever operation amount detection unit 27 includes a pressure sensor. The pressure sensor detects pilot pressure generated in accordance with an operation of the operation lever, and voltage and the like outputted by the pressure sensor are converted into a lever operation amount. Accordingly, the lever operation amount is obtained. The lever operation amount is outputted to a pump controller 33 as an electrical signal. If the operation lever 26 is an electric lever, the lever operation amount detection unit 27 includes electrical detection means such as a potentiometer, and converts voltage and the like, which are generated in accordance with a lever operation amount to obtain the lever operation amount.

A fuel adjustment dial (throttle dial) 28 and a mode switch unit 29 are provided in the cab 6. The fuel adjustment dial (throttle dial) 28 is a switch for setting the amount of fuel to be supplied to the engine 17, and a set value of the fuel adjustment dial (throttle dial) 28 is converted into an electrical signal to be outputted to an engine controller 30.

The engine controller 30 includes an arithmetic unit such as a CPU (numeric data processor) and memory (storage device). The engine controller 30 generates a control command signal based on the set value of the fuel adjustment dial (throttle dial) 28. A common rail control unit 32 receives the control signal, and adjusts the amount of fuel injection into the engine 17. In other words, the engine 17 is an engine capable of common rail electrical control, can produce an aimed output by controlling a fuel injection amount appropriately, and can freely set torque that can be outputted at some engine speed at a certain moment.

The mode switch unit 29 is a portion that sets the working mode of the excavator 1 to a power mode or economy mode, and includes an operation button and a switch, or a touch panel, which are provided in the cab 6. The operator of the excavator 1 can switch the working mode by operating these operation button and the like. The power mode is a working mode for performing engine control and pump control where fuel consumption is suppressed while a large amount of work is maintained. The economy mode is a working mode for performing engine control and pump control to ensure the operation speed of the work equipment 3 at light-load work while fuel consumption is further suppressed. In the setting (switching of the working mode) by the mode switch unit 29, an electrical signal is outputted to the engine controller 30 and the pump controller 33. In the power mode, the output torque of the engine 17 and the absorption torque of the hydraulic pump 18 are matched in an area where the engine speed and output torque of the engine 17 are relatively high. Moreover, in the economy mode, matching is performed at engine output that is lower than the case of the power mode.

The pump controller 33 receives signals transmitted from the engine controller 30, the mode switch unit 29, the lever operation amount detection unit 27, and generates a control command signal for controlling the hydraulic pump 18 to incline its swash plate and adjusting the discharge amount of hydraulic oil from the hydraulic pump 18. A signal from a swash plate angle sensor 18a that detects the angle of the swash plate of the hydraulic pump 18 is inputted into the pump controller 33. The swash plate angle sensor 18a detects the swash plate angle; accordingly, it is possible to compute the pump capacity of the hydraulic pump 18. A pump pressure detection unit 20a for detecting the pump discharge pressure of the hydraulic pump 18 is provided in a control valve 20. The detected pump discharge pressure is converted into an electrical signal and inputted into the pump controller 33. The engine controller 30 and the pump controller 33 are connected to an in-vehicle LAN such as CAN (Controller Area Network) to mutually transmit and receive information.

[Outline of Engine Control]

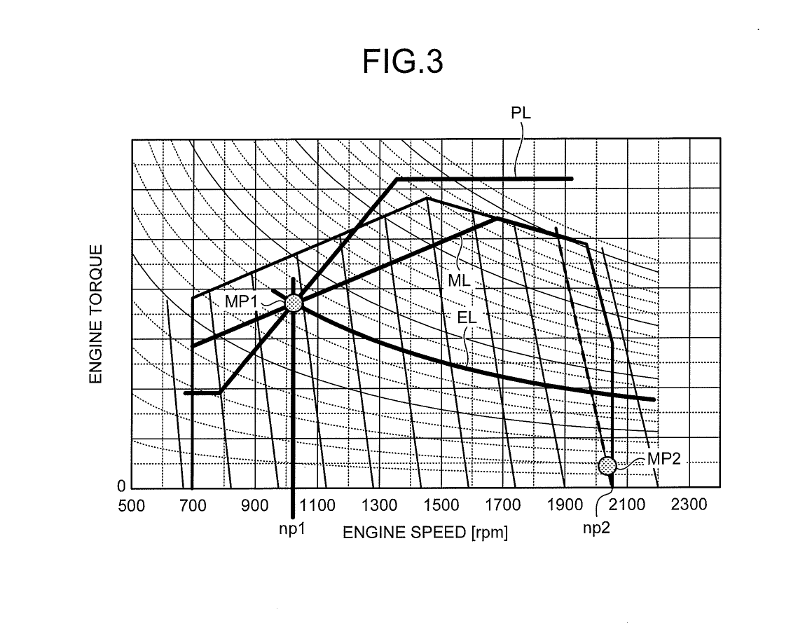

Firstly, a description will be given of an outline of engine control with reference to a torque diagram illustrated in FIG. 3. The engine controller 30 acquires information (signals representing the operating states) such as a lever operation amount, the working mode, and the set value of the fuel adjustment dial (throttle dial) 28, and the swing velocity (swing speed) of the upper structure 5, and obtains an engine output command value. The engine output command value represents an equivalent horsepower curve (engine output command value curve) EL on the torque diagram, and is a curve that restricts the engine output.

If a load is being applied to the work equipment 3, the engine output is not restrained by the droop line, and the work equipment 3 is operated by matching the engine output with the hydraulic pump output at an intersection point (matching point) MP1 of the engine output command value curve EL and the pump absorption torque line PL. It is preferable that the matching point MP1 is on the target matching route ML. The engine speed at the target matching point MP1 is a target matching speed np1, and is, for example, in the vicinity of 1000 rpm in FIG. 3. Consequently, the work equipment 3 can obtain sufficient output, and the engine 17 is driven at low speeds; accordingly, it is possible to keep fuel consumption low.

On the other hand, if the load of the work equipment 3 is released, and the flow rate of hydraulic oil to the hydraulic cylinders 14, 15 and 16 of the work equipment 3 is necessary, in other words, the operation speed of the work equipment 3 needs to be ensured, the engine controller 30 determines a no-load maximum speed np2 (e.g., in the vicinity of 2050 rpm in FIG. 3) corresponding to information such as the lever operation amount, the swing speed of the upper structure 5, and the set value of the fuel adjustment dial (throttle dial) 28, and drives the engine 17 by controlling engine droop within engine speed between the target matching speed np1 and the no-load maximum speed np2. By performing such control, a shift is made from the matching point MP1 on the low speed side to a matching point MP2 on the high speed side if a shift is made from a state where a load is being applied to the work equipment 3 to a state where the load is released. Accordingly, a sufficient flow rate of hydraulic oil discharged from the hydraulic pump 18 can be supplied to the hydraulic cylinders 14, 15 and 16, and the operation speed of the work equipment 3 can be ensured. Moreover, the engine output is restricted by the engine output command value curve EL; accordingly, energy is not consumed wastefully. The no-load maximum speed np2 is not limited to a maximum speed that the engine can output.

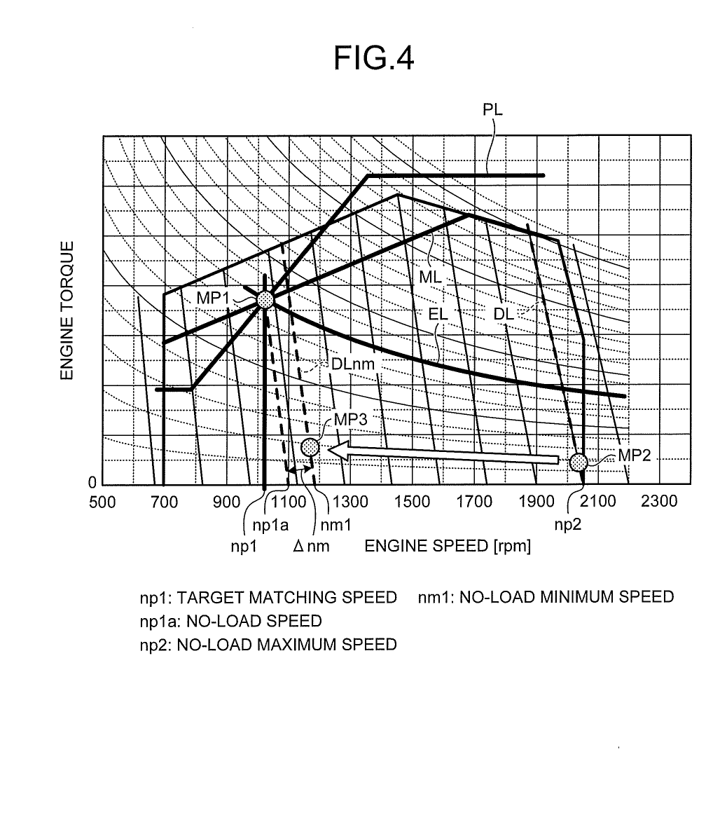

Here, if the load of the work equipment 3 is further released, when the engine 17 continues to be driven in the high speed area, fuel is consumed to lead to worse fuel consumption. Therefore, if the load is released, and not a high flow rate of and pressure of discharge of hydraulic oil from the hydraulic pump 18 are necessary, for example, as in the operation of the bucket 13 only, in other words, if the pump capacity is not full, control is performed such that the droop line DL in the high speed area is shifted to the low speed area, as illustrated in FIG. 4. As described above, the pump capacity is detected by the swash plate angle sensor 18a, and the droop line DL is shifted according to the magnitude of the detected value. For example, if the pump capacity is detected to be larger than a predetermined value, the flow rate of hydraulic oil is necessary; accordingly, the droop line DL is shifted to the high speed area to increase the engine speed. If the pump capacity is detected to be smaller than the predetermined value, the flow rate of hydraulic oil is unnecessary; accordingly, the droop line DL is shifted to the low speed area to reduce the engine speed. By performing such control, it is possible to suppress wasted fuel consumption due to engine drive in the high speed area.

[Details of Engine Control]

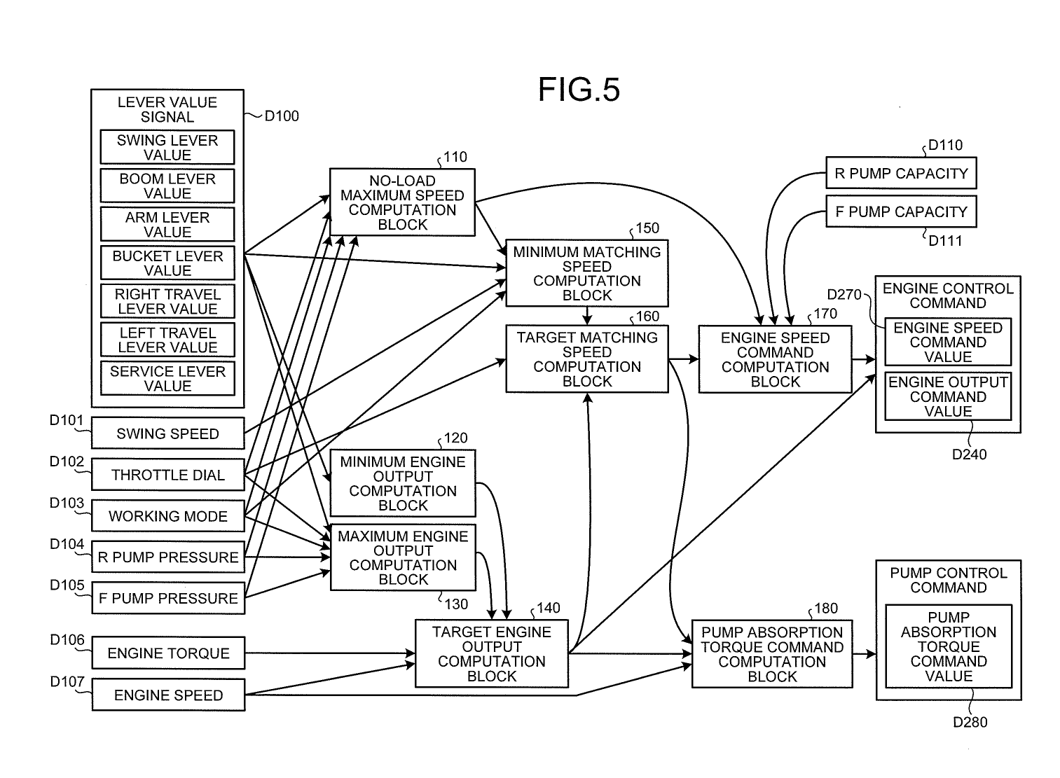

FIG. 5 illustrates an entire control flow by the engine controller 30 or the pump controller 33. The engine controller 30 or the pump controller 33 finally computes an engine speed command value and an engine output command value as engine control commands, and computes a pump absorption torque command value as a pump control command.

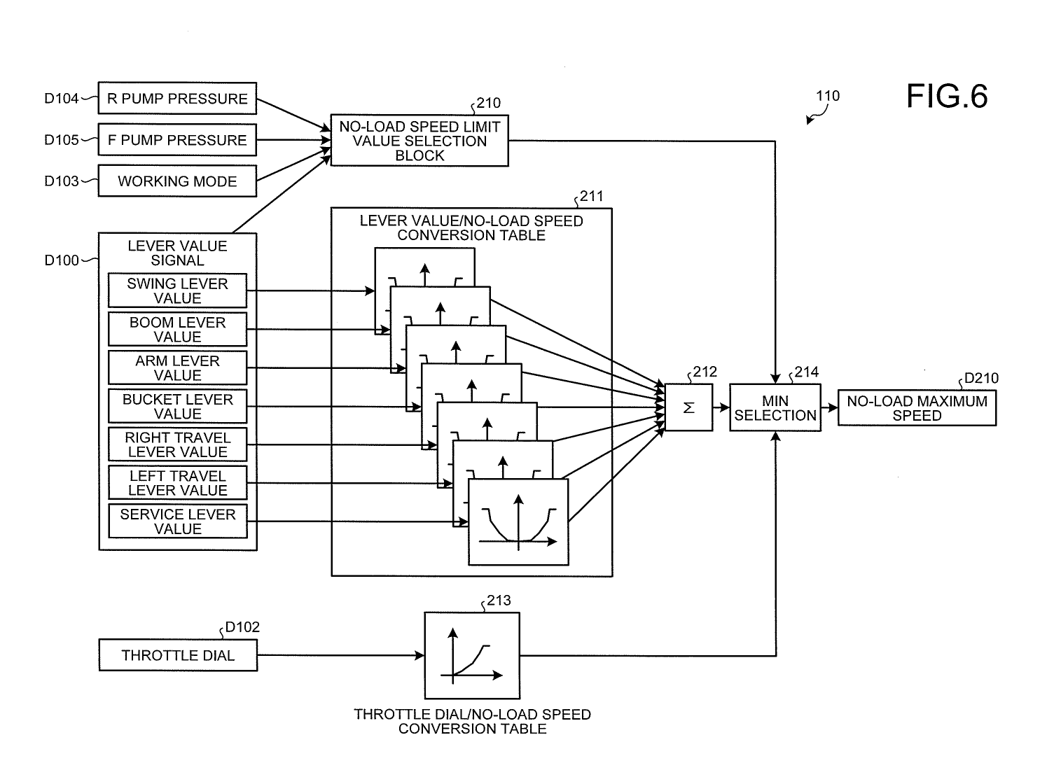

A no-load maximum speed computation block 110 computes a no-load maximum speed D210 (np2) that is a value being an upper limit of the engine speed command value by a detailed control flow illustrated in FIG. 6. In a state where the pump capacity of the hydraulic pump 18 is at its maximum, the flow rate of the hydraulic pump 18 (hydraulic pump discharge flow rate) is the product of the engine speed and the pump capacity, and the flow rate of the hydraulic pump 18 (hydraulic pump discharge flow rate) is proportional to the engine speed. Accordingly, the no-load maximum speed D210 and the flow rate of the hydraulic pump 18 (pump maximum discharge flow rate) is in a proportional relationship. Therefore, firstly, the total sum of no-load speeds obtained by lever value signals D100 (lever operation amounts) is obtained by a summation unit 212 as a candidate value of the no-load maximum speed D210. The lever value signals D100 (signals indicating lever operation amounts) include a swing lever value, a boom lever value, an arm lever value, a bucket lever value, a right travel lever value, a left travel lever value and a service lever value. The service lever value is a value indicating, in a case of including a hydraulic circuit to which a new hydraulic actuator can be connected, a lever operation amount that operates the hydraulic actuator. The lever value signals are converted into no-load speeds by a lever value/no-load speed conversion table 211 illustrated in FIG. 6. A no-load speed of the sum total of the converted values, the sum total being obtained by the summation unit 212, is outputted to a minimum value selection unit (MIN selection) 214.

On the other hand, a no-load speed limit value selection block 210 uses four pieces of information of the operation amounts of lever value signals D100, pump pressures D104 and D105 being discharge pressures of the hydraulic pump 18, and a working mode D103 set by the mode switch unit 29 to determine which operation pattern (work pattern) the operator of the excavator 1 is currently carrying out, and selects and decides a preset no-load speed limit value for the operation pattern. The decided no-load speed limit value is outputted to the minimum value selection unit 214. With regard to the determination of the operation pattern (work pattern), for example, if the arm lever is inclined toward an excavation direction and also the pump pressure is higher than a certain set value, it is determined that the excavator 1 is attempting to perform heavy excavation work. In a case of combined operations where the swing lever is inclined and the boom lever is inclined toward a rising direction, it is determined that the excavator 1 is attempting to perform hoist swing work. In this manner, the determination of the operation pattern (work pattern) is to predict the operation that the operator is attempting to perform at that point. The hoist swing operation is work to excavate the soil with the bucket 13, swing the upper structure 5 while raising the boom 11, and remove the soil in the bucket 13 at a desired swing stop position.

On the other hand, a candidate value of the no-load maximum speed is determined from the setting state (set value) of the fuel adjustment dial 28 (throttle dial D102). In other words, a signal representing the set value of the fuel adjustment dial 28 (throttle dial D102) is received, and the set value is converted into a candidate value of the no-load maximum speed by a throttle dial/no-load speed conversion table 213 to be outputted to the minimum value selection unit 214.

The minimum value selection unit 214 selects a minimum value from three values of a no-load speed obtained from the lever value signals D100, the no-load speed limit value obtained by the no-load speed limit value selection block 210, and the no-load speed obtained from the set value of the throttle dial D102, and outputs the no-load maximum speed D210 (np2).

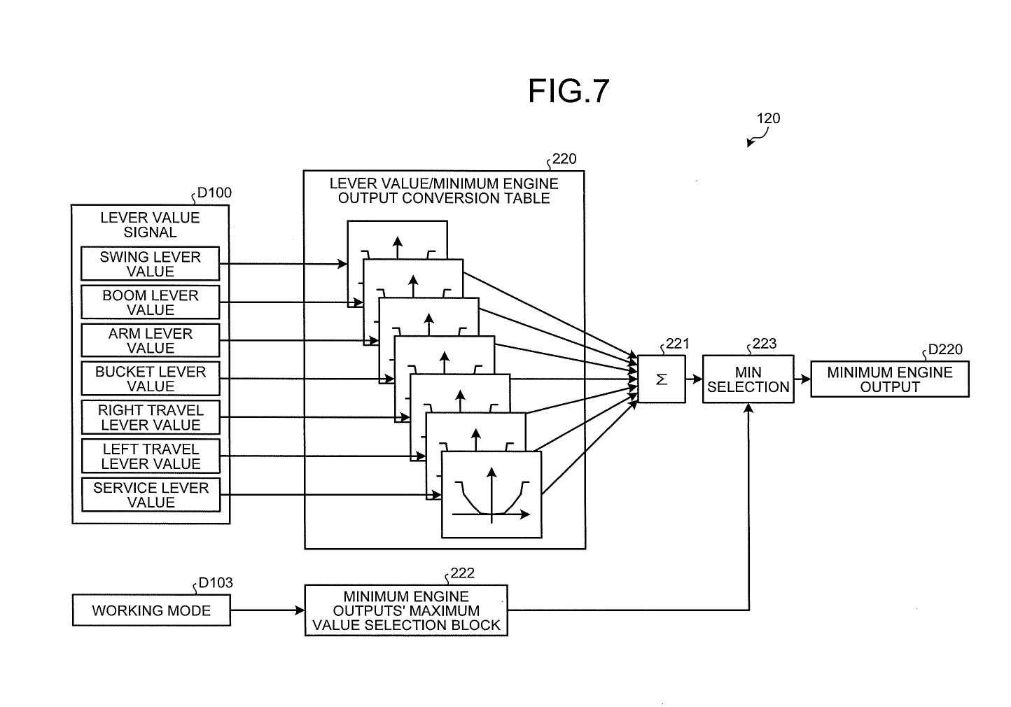

FIG. 7 is a detailed control flow of a minimum engine output computation block 120. As illustrated in FIG. 7, the minimum engine output computation block 120 computes a minimum engine output D220 that is a value being a lower limit of the engine output command value. Similarly to the computation of the no-load maximum speed, a lever value/minimum engine output conversion table 220 converts the lever value signals D100 into minimum engine outputs, respectively, and a summation unit 221 outputs the sum total of them to a minimum value selection unit (MIN selection) 223.

On the other hand, a maximum value selection block 222 of the minimum engine outputs outputs to the minimum value selection unit 223 an upper limit value corresponding to the working mode D103 set by the mode switch unit 29. The minimum value selection unit 223 compares the sum total of the minimum engine outputs corresponding to the lever value signals D100 with the upper limit value corresponding to the working mode D103, and selects a minimum value to output as the minimum engine output D220.

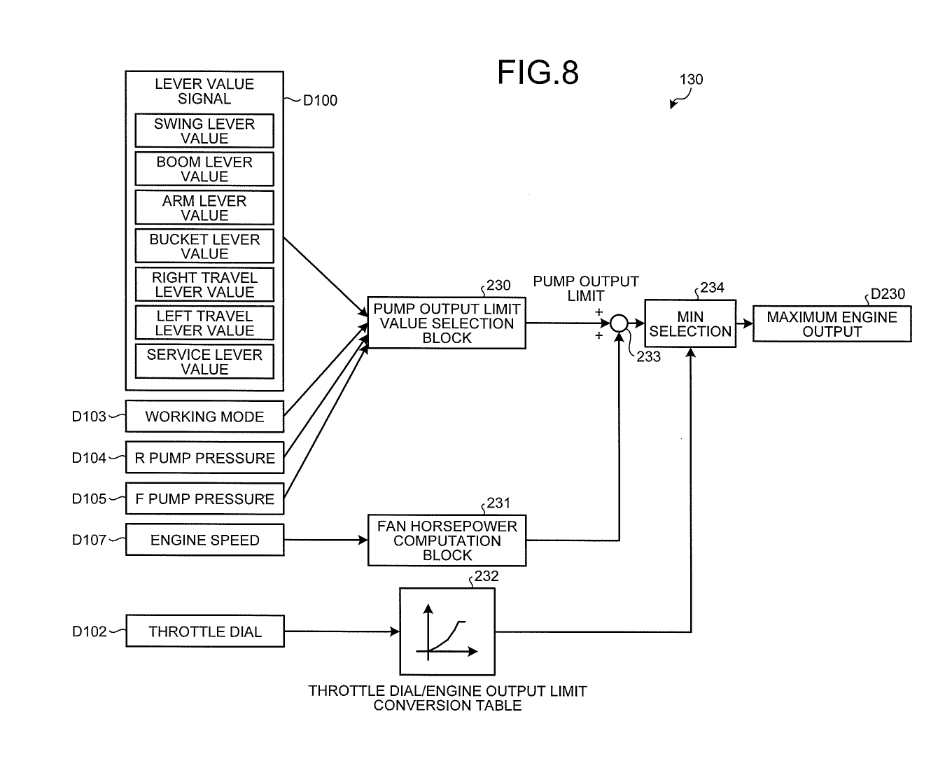

FIG. 8 is a detailed control flow of a maximum engine output computation block 130. As illustrated in FIG. 8, the maximum engine output computation block 130 computes a maximum engine output D230 that is a value being an upper limit of the engine output command value. Similarly to the computation by the no-load maximum speed computation block 110, a pump output limit value selection block 230 uses information of the operation amounts of the lever value signals D100, the pump pressures D104 and D105, the set value of the working mode D103 to determine a current operation pattern, and selects a pump output limit value for each operation pattern. An addition unit 233 adds the selected pump output limit value to fan horsepower computed by a fan horsepower computation block 231 from an engine speed D107 detected by an unillustrated speed sensor. The added value (hereinafter referred to as the additional value), and the engine output limit value converted by a throttle dial/engine output limit conversion table 232 in accordance with the set value of the fuel adjustment dial 28 (throttle dial D102) are outputted to a minimum value selection unit (MIN selection) 234. The minimum value selection unit 234 selects a minimum value between the additional value and the engine output limit value, and outputs the minimum value as the maximum engine output D230.

The fan is a fan provided in the vicinity of a radiator for cooling the engine 17, is for blowing air at the radiator, and is for being driven by rotating in conjunction with the drive of the engine 17. The fan horsepower is obtained by being simply computed using the following equation:

Fan horsepower=fan's rated horsepower×(engine speed/engine speed at the fan's rating)̂3

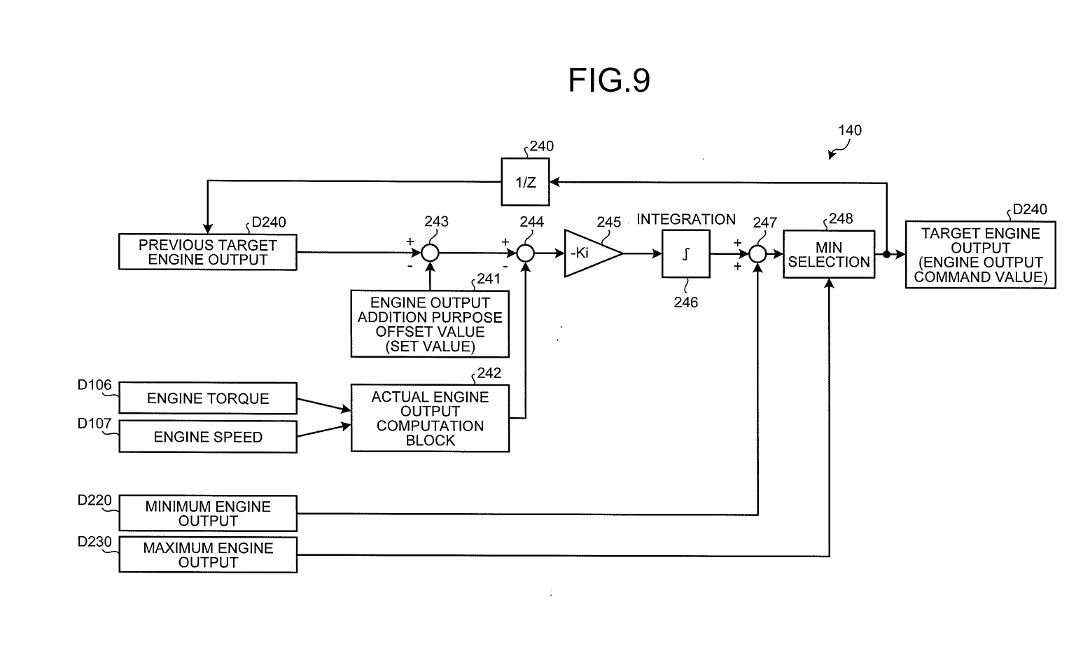

FIG. 9 is a detailed control flow of a target engine output computation block 140. As illustrated in FIG. 9, the target engine output computation block 140 computes a target engine output D240. A subtraction unit 243 subtracts an engine output addition purpose offset value 241 set as a fixed value from a previous target engine output D240 obtained by previous computation. A subtraction unit 244 obtains a deviation where the actual engine output computed by an actual engine output computation block 242 is subtracted from the subtracted value. A multiplication unit 245 multiplies the deviation by a value multiplied by certain gain (−Ki). An integration unit 246 integrates the multiplied value. An addition unit 247 adds to the integrated value the minimum engine output D220 obtained by being computed by the minimum engine output computation block 120. A minimum value selection unit (MIN selection) 248 outputs a minimum value between the added value and the maximum engine output D230 obtained by being computed by the maximum engine output computation block 130, as the target engine output D240. The target engine output D240 is used as the engine output command value of the engine control command as illustrated in FIG. 5. The target engine output D240 indicates the engine output command value curve EL illustrated in FIG. 3 or 4. The actual engine output computation block 242 carries out a computation using the following equation:

Actual engine output (kW)=2π÷60×engine speed×engine torque÷1000

based on a fuel injection amount and engine speed, which are commanded by the engine controller 30, engine torque D106 estimated from air temperature and the like, and the engine speed D107 detected by an unillustrated speed sensor, and obtains the actual engine output.

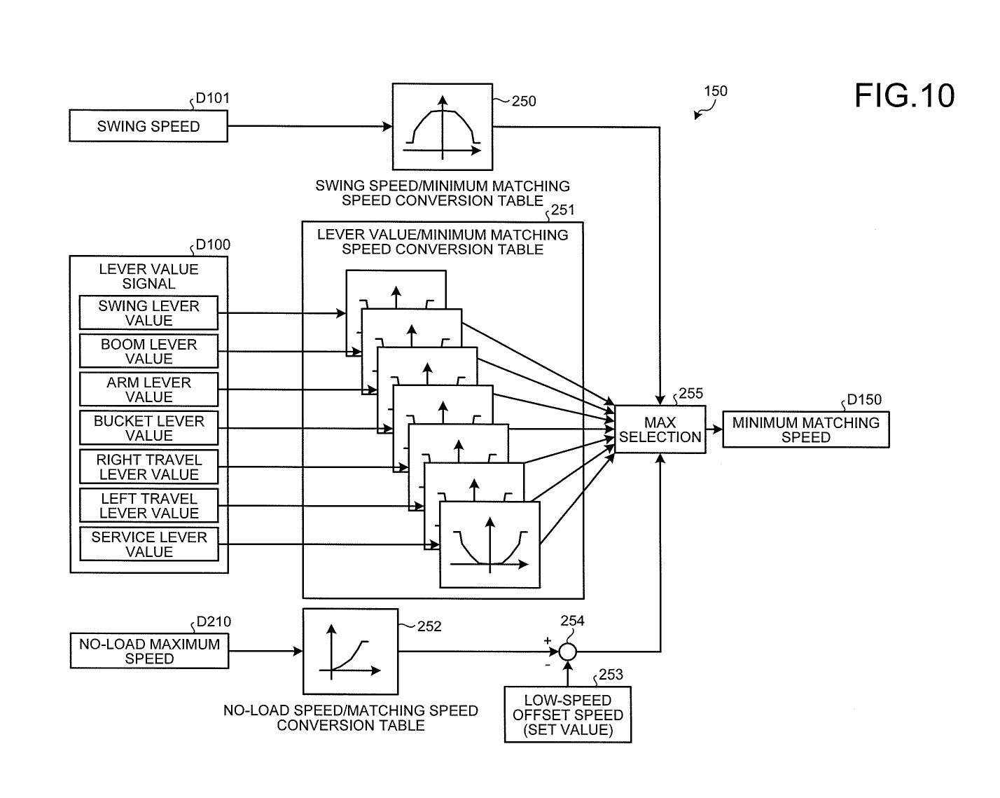

FIG. 10 is a detailed control flow of a minimum matching speed computation block 150. As illustrated in FIG. 10, the minimum matching speed computation block 150 computes a minimum matching speed D150 being an engine speed that is the minimum to be increased at work. With respect to the minimum matching speed D150, values that the lever value signals D100 are converted by a lever value/minimum matching speed conversion table 251 are set as candidates of the minimum matching speed D150, and outputted to a maximum value selection unit (MAX selection) 255, respectively.

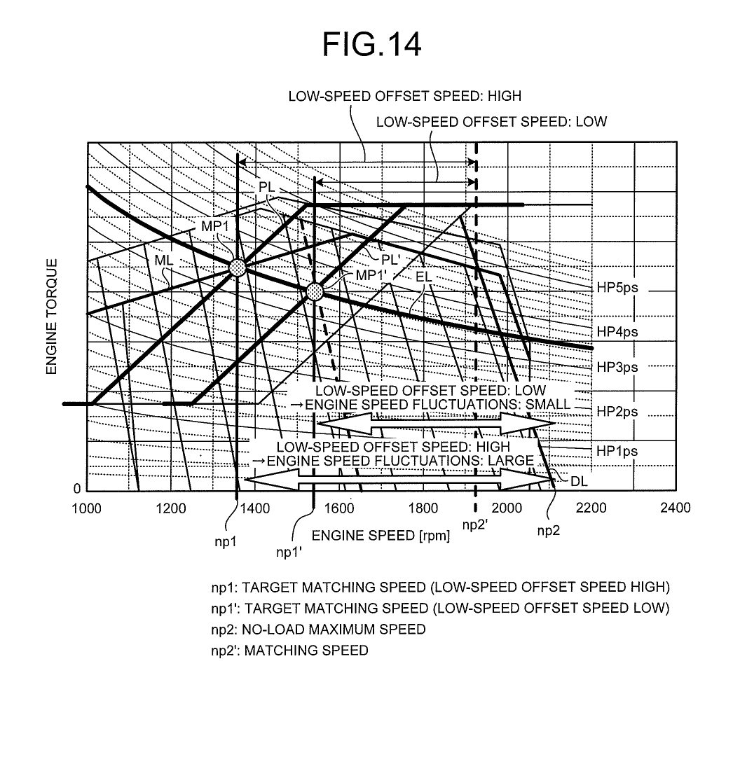

On the other hand, similarly to the target matching speed np1, a no-load speed/matching speed conversion table 252 converts and outputs the no-load maximum speed D210 (np2) obtained by the no-load maximum speed computation block 110, setting, as a matching speed np2′, an engine speed at an intersection point of the droop line DL and the target matching route ML that intersects at the no-load maximum speed np2 (refer to FIG. 14). Furthermore, a low offset speed is subtracted from the matching speed np2′, and the value obtained as a result is outputted as the candidate value of the minimum matching speed D150 to the maximum value selection unit (MAX selection) 255. The significance of use of a low offset speed and the magnitude of its value are described below.

Moreover, a swing speed/minimum matching speed conversion table 250 converts a swing speed D101 as the candidate value of the minimum matching speed D150 to output to the maximum value selection unit 255. The swing speed D101 is a value that the swing speed (velocity) of the swing hydraulic motor 31 of FIG. 2 is detected by a speed sensor such as a resolver or a rotary encoder. The swing speed/matching speed conversion table 250 increases the minimum matching speed when the swing speed D101 is zero as illustrated in FIG. 10, and converts the swing speed D101 with a characteristic that reduce the minimum matching speed with increase in the swing speed D101. The maximum value selection unit 255 selects a maximum value from these minimum matching speeds and outputs the maximum value as the minimum matching speed D150.

Here, in the embodiment, if the load is released, the engine speed increases up to the no-load maximum speed np2 at the maximum, and, if a sufficient load is applied, the engine speed reduces up to the target matching speed np1. In this case, the engine speed fluctuates greatly according to the magnitude of the load. The operator of the excavator 1 may take the great fluctuation in engine speed as an uncomfortable feeling (feeling of lack of power) such as that the operator feels that the excavator 1 is not exerting its power. Therefore, as illustrated in FIG. 14, a low offset speed is used to change the range of fluctuations in engine speed according to the magnitude of the low offset speed to be set; accordingly, it is possible to remove the uncomfortable feeling. In other words, if the low offset speed is reduced, the range of fluctuations in engine speed is narrowed, and, if the low offset speed is increased, the range of fluctuations in engine speed is widened. The uncomfortable feeling of the operator varies depending on the operating state of the excavator 1 such as a state where the upper structure 5 is swinging or where the work equipment 3 is performing excavation work, even if the ranges of fluctuations in engine speed are the same. It is more unlikely for the operator to feel lack of power in the state where the upper structure 5 is swinging than in the state where the work equipment 3 is performing excavation work even if the engine speed reduces somewhat. Accordingly, there is no problem in setting an engine speed to reduce further in the state where the upper structure 5 is swinging than in the state where the work equipment 3 is performing excavation work. In this case, the engine speed reduces; accordingly, fuel consumption improves. It is possible to similarly set the range of fluctuations in engine speed in accordance with not limited to a swing but the operation of another actuator.

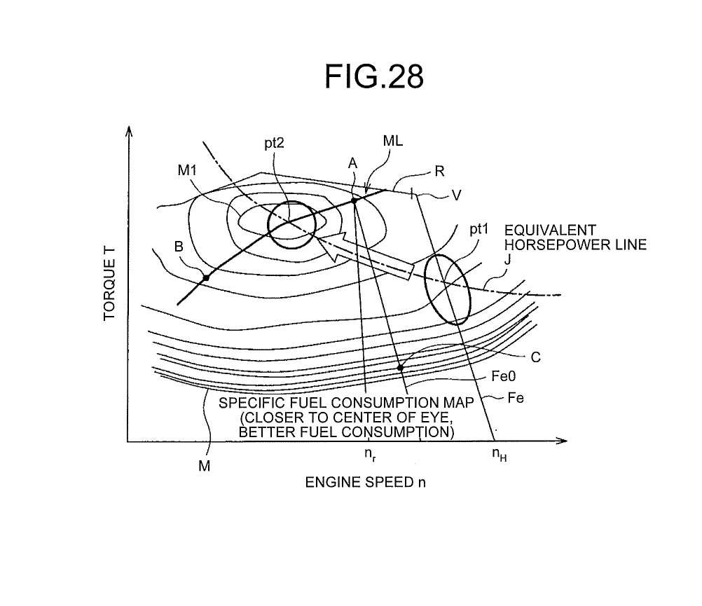

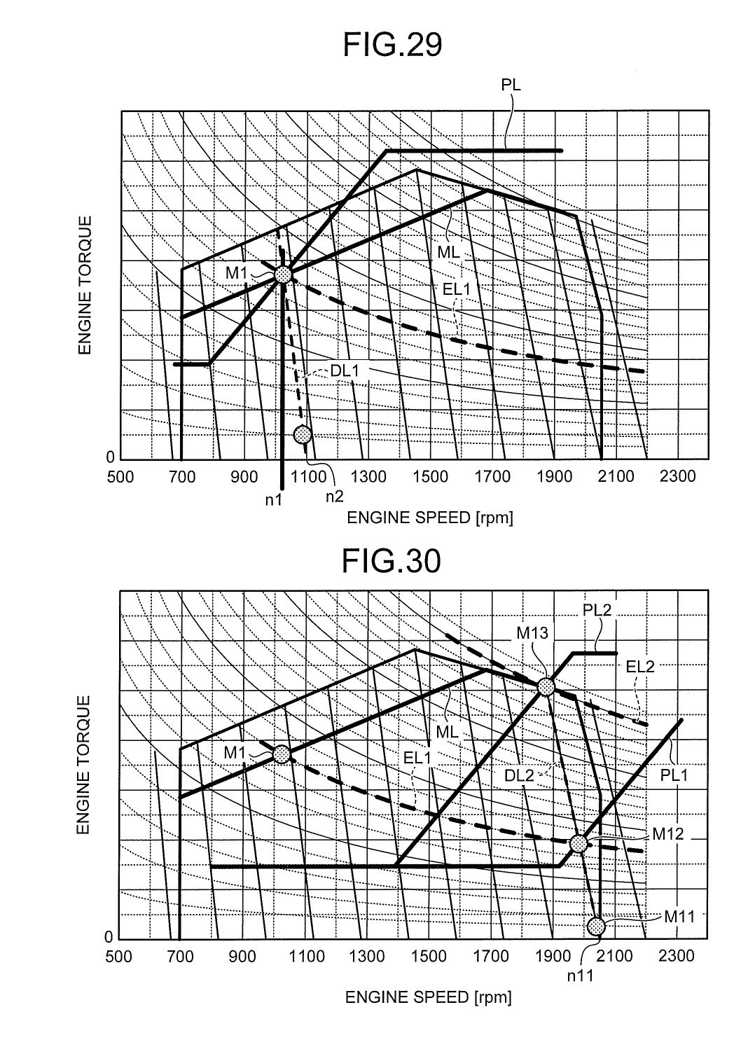

A supplemental description will be given of the torque diagram illustrated in FIG. 14. HP1 to HP5 illustrated in the graph of FIG. 14 correspond to the equivalent horsepower line J illustrated in FIG. 28. ps represents the unit of horsepower (ps). Horsepower increases with a progressive shift from HP1 to HP5. The five curves are exemplary illustrated. An equivalent horsepower curve (engine output command value curve) EL is obtained and set depending on an engine output command value obtained. Hence, there is an infinite number of the equivalent horsepower curves (engine output command value curves) EL, not limited to the five of HP1 to HP5, and a selection is made from them. FIG. 14 illustrates a case where the equivalent horsepower curve (engine output command value curve) EL where horsepower falls between HP3 ps and HP4 ps is obtained and set.

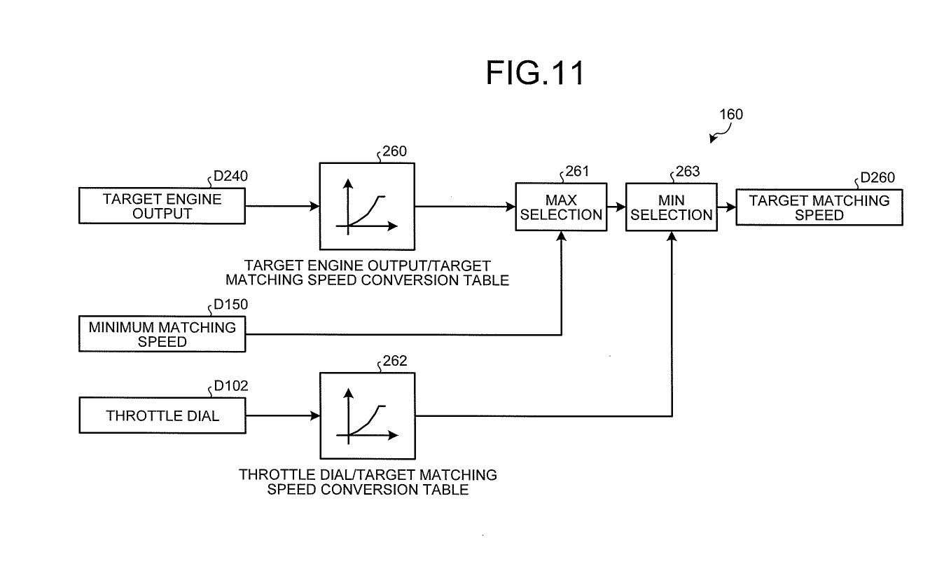

FIG. 11 is a detailed control flow of a target matching speed computation block 160. As illustrated in FIG. 11, the target matching speed computation block 160 computes the target matching speed np1 (D260) illustrated in FIG. 3. The target matching speed D260 is an engine speed that intersects the target engine output D240 (engine output command value curve EL) with the target matching route ML. The target matching route ML is set so as to pass through a point of good specific fuel consumption when the engine 17 operates with certain engine output. Therefore, it is preferable that the target matching speed D260 is decided at an intersection point with the target engine output D240 on the target matching route ML. Consequently, a target engine output/target matching speed conversion table 260 receives the input of the target engine output D240 (engine output command value curve EL) obtained by the target engine output computation block 140, obtains a target matching speed at an intersection point of the target engine output D240 (engine output command value curve EL) and the target matching route ML, and outputs the target matching speed to a maximum value selection unit (MAX selection) 261.

However, according to the computation carried out by the minimum matching speed computation block 150 illustrated in FIG. 10, if the range of fluctuations in engine speed is narrowed, the minimum matching speed D150 becomes higher than the matching speed obtained by the target engine output/target matching speed conversion table 260. Consequently, the maximum value selection unit (MAX selection) 261 compares the minimum matching speed D150 with the matching speed obtained from the target engine output D240, and selects a maximum value to set as a candidate value of the target matching speed D260. Accordingly, a lower limit of the target matching speed is restricted. In FIG. 14, if the low offset speed is low, a deviation from the target matching route ML occurs. However, a target matching point is set not to MP1 but to MP1′, and the target matching speed D260 becomes not np1 but np1′. Moreover, similarly to the no-load maximum speed D210 obtained by the no-load maximum speed computation block 110, an upper limit of the target matching speed D260 is restricted also by the set value of the fuel adjustment dial 28 (throttle dial D102). In other words, a throttle dial/target matching speed conversion table 262 receives the input of the set value of the fuel adjustment dial 28 (throttle dial D102), and outputs a candidate value of the target matching speed D260 that is converted into a matching speed at an intersection point of a droop line corresponding to the set value of the fuel adjustment dial (throttle dial D102) (droop line that can be subtracted from an engine speed corresponding to the set value of the fuel adjustment dial 28 (throttle dial D102) on the torque diagram), and the target matching route ML. The outputted candidate value of the target matching speed D260 is compared by a minimum value selection unit (MIN selection) 263 with the candidate value of the target matching speed D260, which is selected by the maximum value selection unit 261. A minimum value is selected to output the final target matching speed D260.

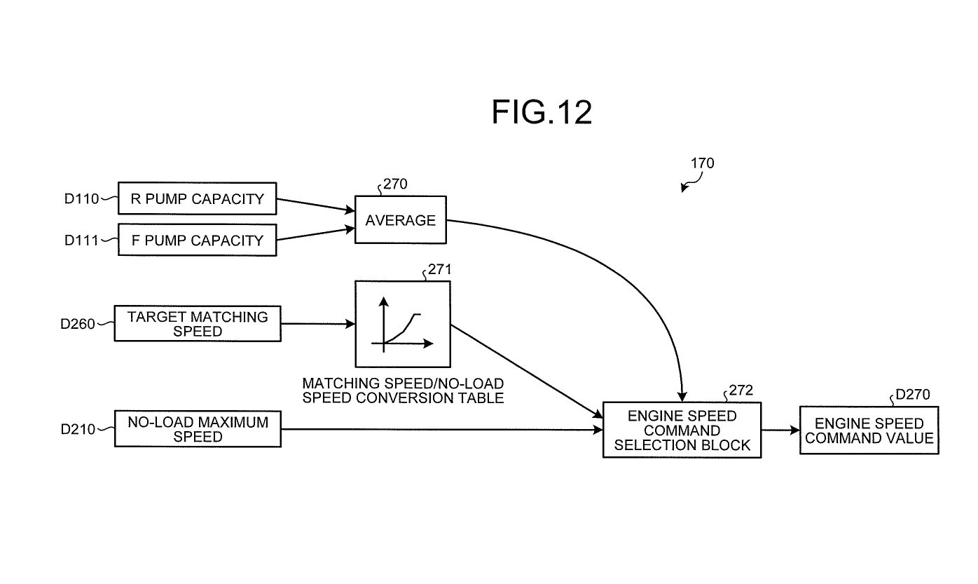

FIG. 12 is a detailed control flow of an engine speed command value computation block 170. A description will hereinafter be given with reference to the torque diagram illustrated in FIG. 4. As illustrated in FIG. 12, the engine speed command value computation block 170 calculates, based on pump capacities D110 and D111 obtained based on the swash plates' angles detected by the swash plate angle sensors 18a of the two hydraulic pumps 18, an average pump capacity that an average unit 270 averages the pump capacities D110 and D111. An engine speed command selection block 272 obtains an engine speed command value D270 (no-load maximum speed np2) in accordance with the magnitude of the average pump capacity. In other words, if the average pump capacity is greater than a certain set value (threshold value), the engine speed command selection block 272 attempts to bring the engine speed command value D270 close to the no-load maximum speed np2 (D210). In short, the engine speed is increased. On the other hand, if the average pump capacity is smaller than the certain set value, an attempt is made to bring the engine speed command value D270 close to an engine speed nm1 to be described below, in other words, the engine speed is reduced. Assuming that an engine speed corresponding to a position where engine torque is brought down from an intersection point of the target matching speed np1 (D260) and the torque on the target matching point MP1 toward zero along the droop line as a no-load speed np1a, the engine speed nm1 is obtained as a value that a lower limit speed offset value Δnm is added to the no-load speed np1a. Conversion to a no-load speed corresponding to the target matching speed D260 is performed by a matching speed/no-load speed conversion table 271. Therefore, the engine speed command value D270 is decided between the no-load minimum speed nm1 and the no-load maximum speed np2, depending on the state of pump capacity. The lower limit offset value Δnm is a preset value, and is stored in the memory of the engine controller 30.

Explaining it specifically, the engine speed command value D270 is brought close to the no-load maximum speed np2 if the average pump capacity is greater than a certain set value, q_com1, and is brought close to a value obtained using the following equation if the average pump capacity is smaller than the certain set value, q_com1.

Engine speed command value D270=.speed np1a that the target matching speed np1 is converted to a no-load speed+lower limit speed offset value Δnm

It is possible to control the droop line with the engine speed command value D270 obtained in this manner, and, if the pump capacity is not full (if the average pump capacity is smaller than the certain set value), it becomes possible to reduce the engine speed (reduce the engine speed to nm1 (no-load minimum speed)) as illustrated in FIG. 4, and it becomes possible to suppress fuel consumption and improve fuel efficiency. The set value, q_com1, is a preset value, and is stored in the memory of the pump controller 33. With respect to the set value, q_com1, an engine speed increase side and an engine speed reduction side may be divided to provide two different set values and provide a range where the engine speed does not change.

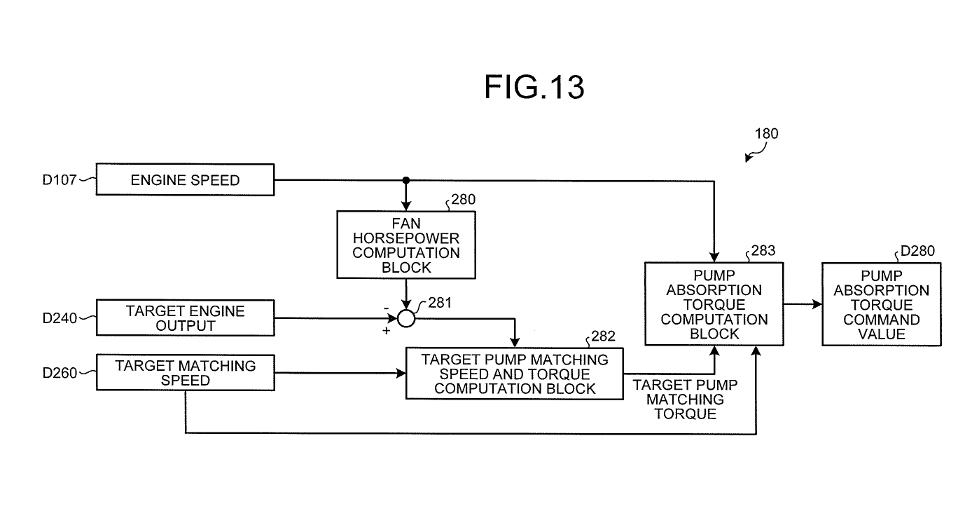

FIG. 13 is a detailed control flow of a pump absorption torque command value computation block 180. As illustrated in FIG. 13, the pump absorption torque command value computation block 180 obtains a pump absorption torque command value D280 using a current engine speed D107, the target engine output D240, and the target matching speed D260. A fan horsepower computation block 280 computes fan horsepower using the engine speed D107. The fan horsepower is obtained using the above-mentioned formula. A subtraction unit 281 inputs, into a target pump matching speed and torque computation block 282, an output (target absorption horsepower) that subtracts the obtained fan horsepower from the target engine output D240 obtained by the target engine output computation block 140. The target matching speed D260 obtained by the target matching speed computation block 160 is further inputted into the target pump matching speed and torque computation block 282. The target matching speed D260 is set as a target matching speed of the hydraulic pump 18 (target pump matching speed). The target pump matching speed and torque computation block 282 carries out a computation as indicated in the following equation:

Target pump matching torque=(60×1000×(target engine output−fan horsepower)/(2π×target matching speed)

The obtained target pump matching torque is outputted to a pump absorption torque computation block 283.

The target pump matching torque outputted from the target pump matching speed and torque computation block 282, the engine speed D107 detected by the speed sensor, and the target matching speed D260 are inputted into the pump absorption torque computation block 283. In the pump absorption torque computation block 283, a computation is carried out as indicated in the following equation and the pump absorption torque value D280 being the computation result is outputted.

Pump absorption torque=target pump matching torque−Kp×(target matching speed−engine speed)

Here, Kp is control gain.

By executing such a control flow, as can be seen from the above equation, if the actual engine speed D107 is greater than the target matching speed D260, the pump absorption torque command value D280 increases. Conversely, if the actual engine speed D107 is smaller than the target matching speed D260, the pump absorption torque command value D280 decreases. On the other hand, the engine output is controlled such that the target engine output D240 is the upper limit. As a result, the engine speed is stabilized in the vicinity of the target matching speed D260, and the engine 17 is driven.

Here, as described above, in the engine speed command value computation block 170, a minimum value of the engine speed command value D270 is a value obtained by a computation of Engine speed command value=speed np1a that target matching speed np1 is converted to no-load speed+lower limit speed offset value Δnm

and the droop line of the engine is set to a high speed to which a lower limit speed offset value Δnm is added at the minimum, to the target matching speed. Consequently, according to the first embodiment, even if the actual absorption torque of the hydraulic pump 18 (actual pump absorption torque) varies somewhat corresponding to the pump absorption torque command, matching is performed in a range that does not fall on the droop line. Accordingly, the engine output is restricted on the engine output command value curve EL and the target engine output is controlled to be constant even if the matching speed of the engine 17 fluctuates somewhat. Hence, it becomes possible to lessen fluctuations in engine output even if the actual absorption torque (actual pump absorption torque) varies relative to the pump absorption torque command. As a result, it is possible to keep variations in fuel consumption small, and satisfy the specifications of fuel consumption of the excavator 1. The specification of fuel consumption is, for example, a specification that fuel consumption can be reduced by 10% compared with the conventional excavator.

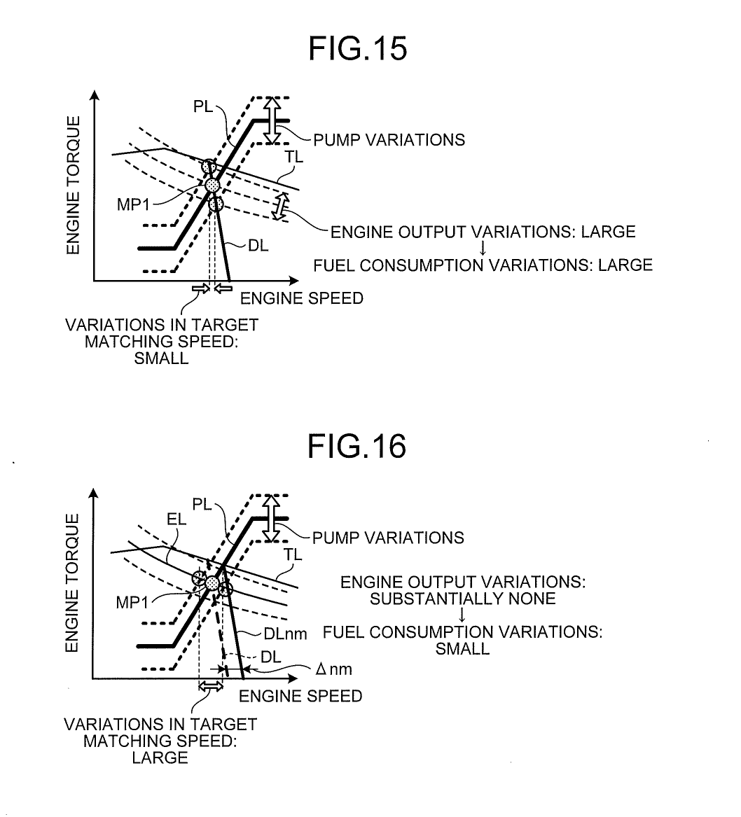

In other words, as illustrated in FIG. 15, an intersection point of the pump absorption torque line PL and the target matching speed is conventionally set to the target matching point MP1; accordingly, if the sequential performance of the hydraulic pump varies greatly, the engine output varies accordingly on the droop line DL. As a result, fuel consumption varies greatly, and it is difficult to satisfy the specifications of fuel consumption for the excavator 1 in some cases. In contrast, according to the first embodiment, as illustrated in FIG. 16, an intersection point of the pump absorption torque line PL and the engine output command value line EL being the equivalent horsepower curve and indicating the upper limit of the engine output is set to the target matching point MP1. Even if the sequential performance of the hydraulic pump varies greatly, the target matching points MP1 vary along the engine output command value curve EL. Consequently, there is substantially no variation in engine output, and as a result, there is substantially no variation in fuel consumption.

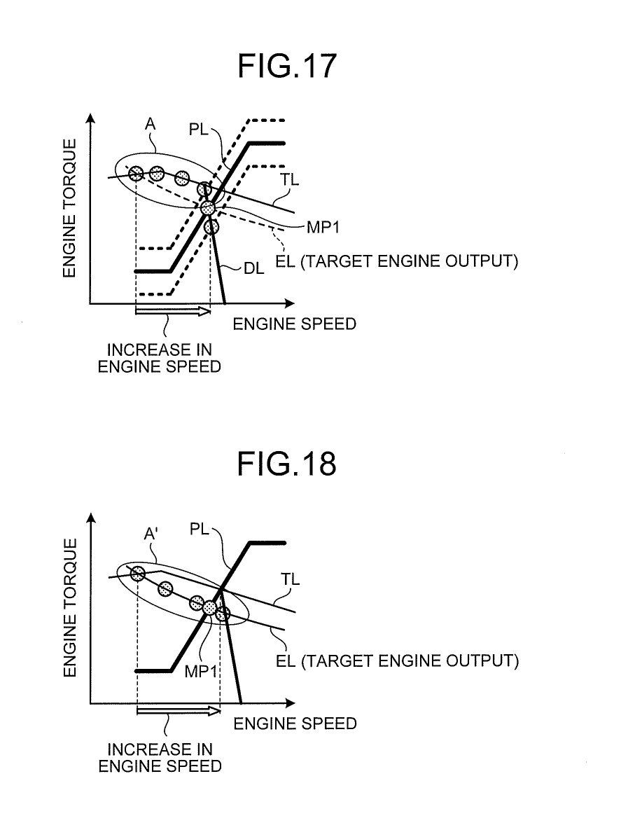

In conventional engine control, as illustrated in FIG. 17, during a period of transition when the engine speed is increased and the engine output moves to the target matching point MP1 from a state where the engine 17 is performing idle rotation, the engine output goes via the maximum output torque line TL and the droop line DL passing through the target matching point MP1. Accordingly, the engine output during the period of transition becomes excessively larger than the target engine output as indicated by an enclosed part A in FIG. 17. Thus, fuel consumption is deteriorated. In contrast, according to the first embodiment, as illustrated in FIG. 18, the intersection point of the pump absorption torque line PL and the engine output command value curve EL is set to the target matching point MP1. Accordingly, during the period of transition, as indicated by an enclosed part A′ in FIG. 18, the engine output shifts to the target matching point MP1 along the engine output command value curve EL. Consequently, even during the period of transition, the same engine output as the target engine output can be obtained. Thus, fuel consumption improves.

### Second Embodiment

The first embodiment is an example where the present invention is applied to the excavator 1 having a structure where the upper structure 5 swings with the hydraulic motor (swing hydraulic motor 31), and the work equipment 3 is all driven by the hydraulic cylinders 14, 15 and 16. However, a second embodiment is an example where the present invention is applied to the excavator 1 having a structure where the upper structure 5 swings with an electric swing motor. A description will hereinafter be given, setting the excavator 1 as the hybrid excavator 1. Unless otherwise specified below, the second embodiment and the first embodiment have the common configurations.

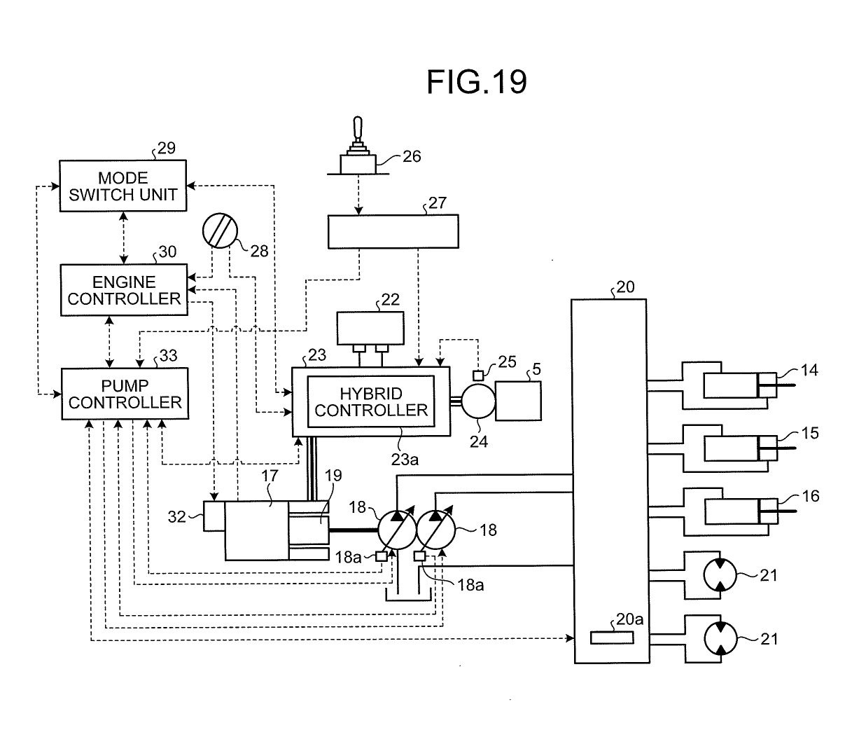

The hybrid excavator 1 has the same main configurations such as the upper structure 5, the undercarriage 4, and the work equipment 3, compared with the excavator 1 illustrated in the first embodiment. However, in the hybrid excavator 1, as illustrated in FIG. 19, the output shaft of the engine 17 is mechanically coupled to a generator 19 in addition to the hydraulic pump 18, and the hydraulic pump 18 and the generator 19 are driven by driving the engine 17. The generator 19 may be mechanically coupled directly to the output shaft of the engine 17, or may be driven by rotating via transmission means such as a belt and a chain attached on the output shaft of the engine 17. Moreover, an electrically-driven swing motor 24 may be used instead of the swing hydraulic motor 31 that is a hydraulic motor of a hydraulic drive system. Accompanied by this, a capacitor 22 and an inverter 23 are included as an electric drive system. Electric power generated by the generator 19 or electric power discharged from the capacitor 22 is supplied to the swing motor 24 via a power cable to swing the upper structure 5. In other words, the swing motor 24 is driven and swing due to powering operation by electric energy supplied from (generated by) the generator 19 or electric energy supplied (discharged) from the capacitor 22. The swing motor 24 supplies (charges) the capacitor 22 with electric energy due to regenerative operation upon speed reduction for a swing. For example, an SR (switched reluctance) motor is used as the generator 19. The generator 19 is mechanically coupled to the output shaft of the engine 17. A rotor shaft of the generator 19 is rotated by the drive of the engine 17. For example, an electric double-layer capacitor is used as the capacitor 22. A nickel metal hydride battery or lithium-ion battery may be used instead of the capacitor 22. The swing motor 24 is provided with a speed sensor 25, detects the speed of the swing motor 24, converts it into an electrical signal, and outputs the electrical signal to a hybrid controller 23a provided in the inverter 23. For example, an interior permanent magnet synchronous motor is used as the swing motor 24. For example, a resolver or rotary encoder is used as the speed sensor 25. The hybrid controller 23a includes a CPU (arithmetic unit such as a numeric data processor), memory (storage device) and the like. The hybrid controller 23a receives signals of detected values by thermistors and temperature sensors such as thermocouples, which are provided to the generator 19, the swing motor 24, the capacitor 22 and the inverter 23, manages excessive increase in temperature of each device such as the capacitor 22 as well as performing charge/discharge control of the capacitor 22, power generation/engine assist control by the generator 19, and powering and regenerative control of the swing motor 24.

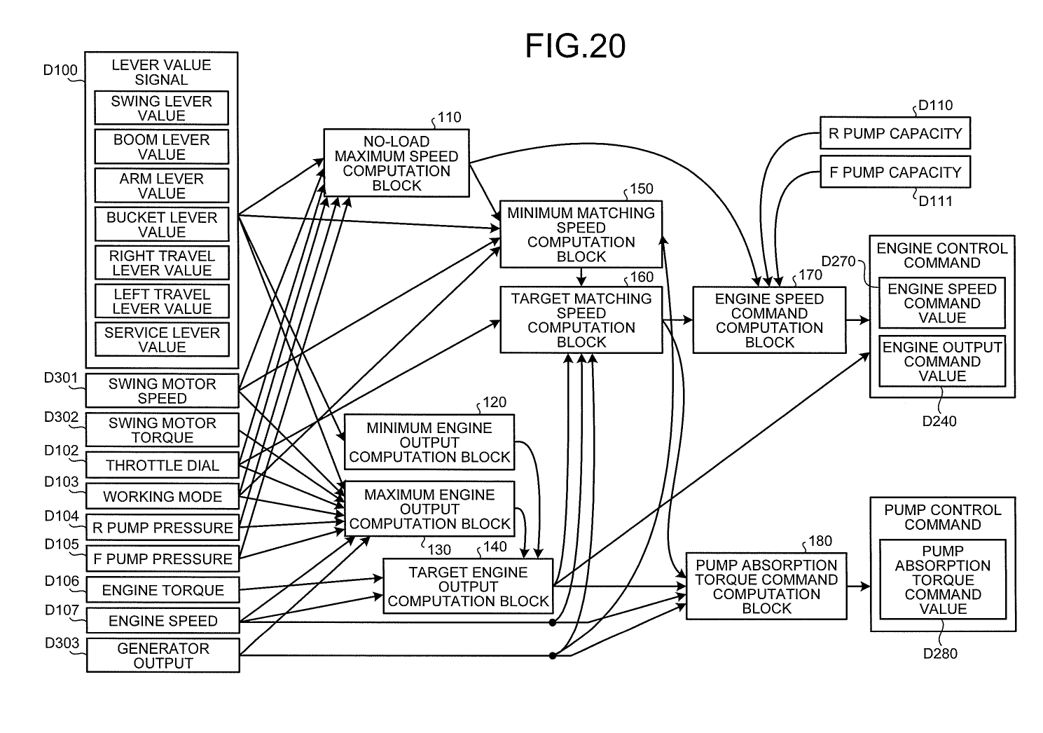

The engine control according to the second embodiments is substantially the same as the one in the first embodiment, and different control points are described below. FIG. 20 illustrates the entire control flow of engine control of the hybrid excavator 1. Points that are different from the entire control flow illustrated in FIG. 5 are that a swing motor speed D301 and swing motor torque D302 of the swing motor 24 are set as input parameters instead of the swing speed D101 of the swing hydraulic motor 31, and further, generator output D303 is added as an input parameter. The swing motor speed D301 of the swing motor 24 is inputted into the no-load maximum speed computation block 110 and the maximum engine output computation block 130 in addition to the minimum matching speed computation block 150. The swing motor torque D302 is inputted into the maximum engine output computation block 130. Moreover, the generator output D303 is inputted into the maximum engine output computation block 130, the minimum matching speed computation block 150, the target matching speed computation block 160, and the pump absorption torque command value computation block 180.

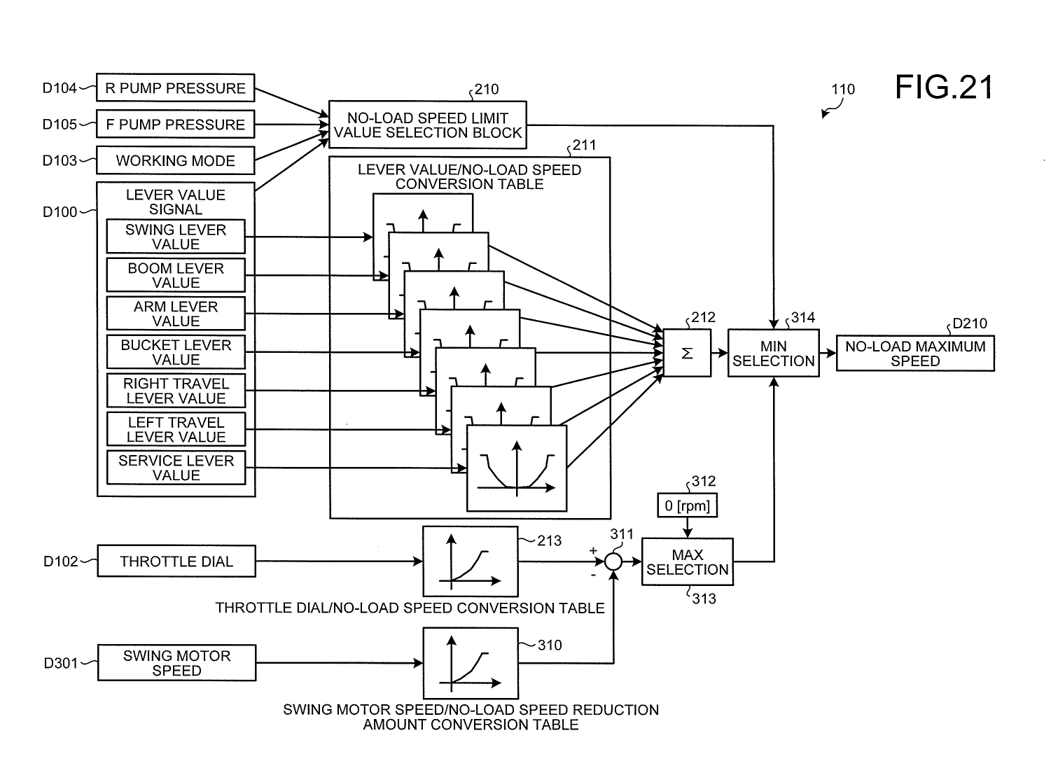

FIG. 21 illustrates a control flow of the no-load maximum speed computation block 110 in the second embodiment, which corresponds to FIG. 6. The hybrid excavator 1 equipped with the electrically-driven swing motor 24 does not need hydraulic pressure as a drive source for a swing. Consequently, among hydraulic oils discharged from the hydraulic pump 18, the flow rate of discharge of hydraulic oil from the hydraulic pump 18, which is for the drive of a swing, may be reduced. Therefore, a subtraction unit 311 subtracts a no-load speed reduction amount obtained by a swing motor speed/no-load speed reduction amount conversion table 310 from the swing motor speed D301, a no-load speed obtained by the throttle dial/no-load speed conversion table 213 from the set value of the fuel adjustment dial 28 (throttle dial D102). The obtained speed is set as a candidate value of the no-load maximum speed D210. A maximum value selection unit (MAX selection) 313 selects a maximum value in between with a zero value 312 so as to prevent a state where a no-load maximum speed becomes a negative value as a result that the no-load speed reduction amount is greater than the no-load maximum speed obtained from the set value of the fuel adjustment dial 28 (throttle dial D102), and a value inputted into the maximum value selection unit 313 becomes a negative value, and passes through a minimum value selection unit (MIN selection) 314 for comparison with a no-load speed limit value outputted by the no-load speed limit value selection block 210. The maximum value selection unit 313 prevents the minimum value selection unit 314 from being provided with the negative value.

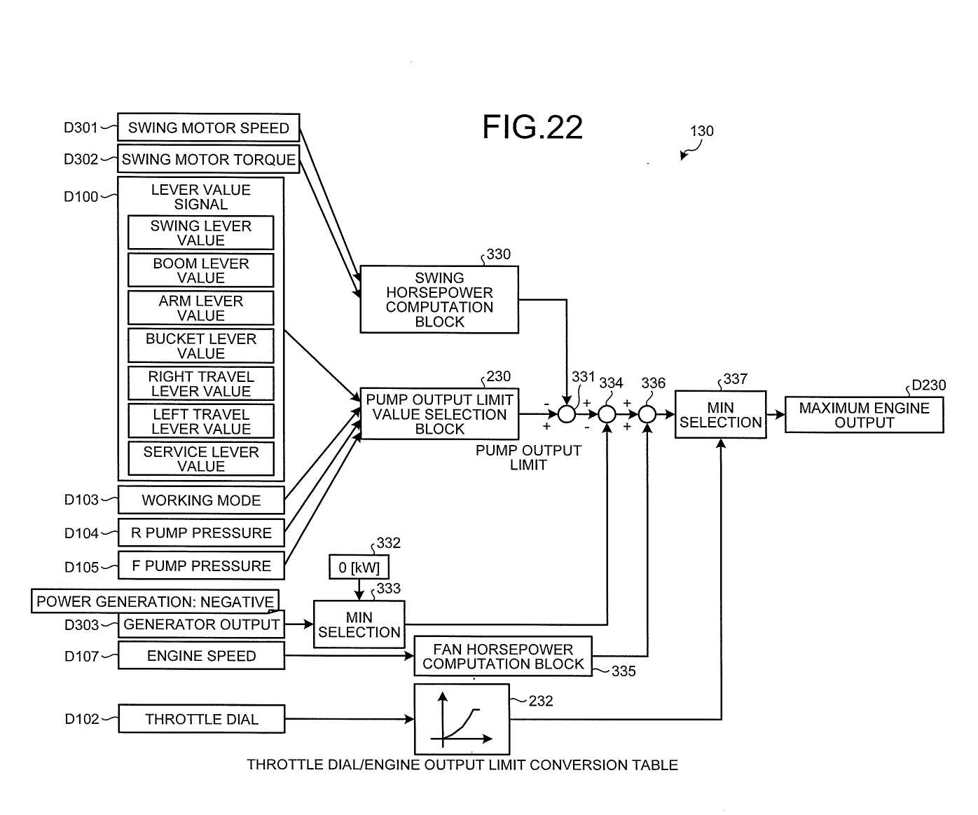

FIG. 22 illustrates a control flow of the maximum engine output computation block 130 in the second embodiment, which corresponds to FIG. 8. In the maximum engine output computation block 130, a swing horsepower computation block 330 computes swing horsepower using the swing motor speed D301 and the swing motor torque D302 as the input parameters, and a fan horsepower computation block 335 computes fan horsepower using the engine speed D107. The swing horsepower and the fan horsepower are added to a pump output limit value via a subtraction unit 331 and an addition unit 336, respectively. Moreover, the generator output D107 of the generator 19 is added to the pump output limit value via a subtraction unit 334. The swing horsepower can be obtained by computing the following equation:

Swing horsepower (kW)=2π60×swing motor speed×swing motor torque 1000×coefficient (set value)

Addition to the swing horsepower and the pump output limit value of the generator output results in subtraction as illustrated in FIG. 22. The hybrid excavator 1 uses the swing motor 24 that is electrically driven by a drive source of electricity being different from the drive source of the engine 17. Accordingly, it is necessary to obtain the swing horsepower and subtract a swing equivalent amount from the pump output limit value. With respect to the generator output, when the generator 19 generates electric power, the plus and minus signs of a value is defined as a minus. A minimum value selection unit 333 makes a comparison in between with a zero value 332, and the negative value is subtracted from the pump output limit value, which practically results in addition. If the generator 19 assists the output of the engine 17, the generator output becomes a positive in terms of a plus and minus of the value. When the generator 19 generates electric power, the generator output is a negative value. Therefore, after a minimum value is selected in between with the zero value 332, the negative generator output is subtracted from the pump output limit, and the generator output is practically added to the pump output limit. In other words, addition is done only when the generator output D303 becomes a negative value. The generator 19 assists the engine 17 to increase the responsiveness of the work equipment 3 when the engine speed needs to be increased from a predetermined speed to a higher speed. However, if output equal to the assist for the engine 17 is removed as engine output at this point, it does not lead to an improvement in the responsiveness of the work equipment 3. Therefore, even if the engine 17 is assisted, the maximum engine output is not subtracted. In other words, even if positive generator output is inputted into the minimum value selection unit 333, zero is outputted from the minimum value selection unit 333 by the selection of a minimum value in between with the zero value 332. A maximum engine output D230 is obtained without subtraction from the pump output limit.

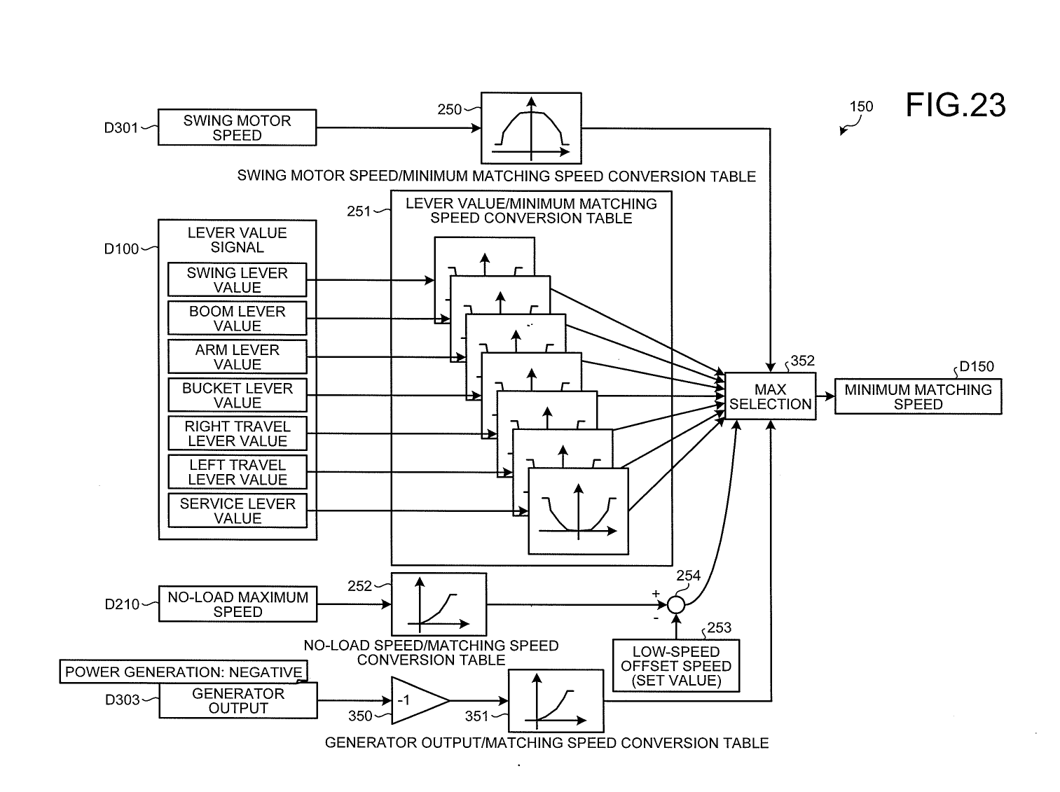

FIG. 23 illustrates a control flow of the minimum matching speed computation block 150 in the second embodiment, which corresponds to FIG. 10. Since a limit value of torque that the generator 19 can output at the maximum (generator maximum torque) is set, it is necessary to increase engine speed in order to generate electric power with output that is large to a certain extent. Consequently, a generator output/matching speed conversion table 351 is used to obtain the engine speed to which it is necessary to be increased at the minimum from the magnitude of the generator output required at any time. The obtained engine speed is outputted to a maximum value selection unit (MAX selection) 352 as a candidate value of the minimum matching speed D150. A gate 350 disposed in the latter stage of the generator output D303 is provided to convert the generator output D303 to a positive value since the generation output D303 is negative.

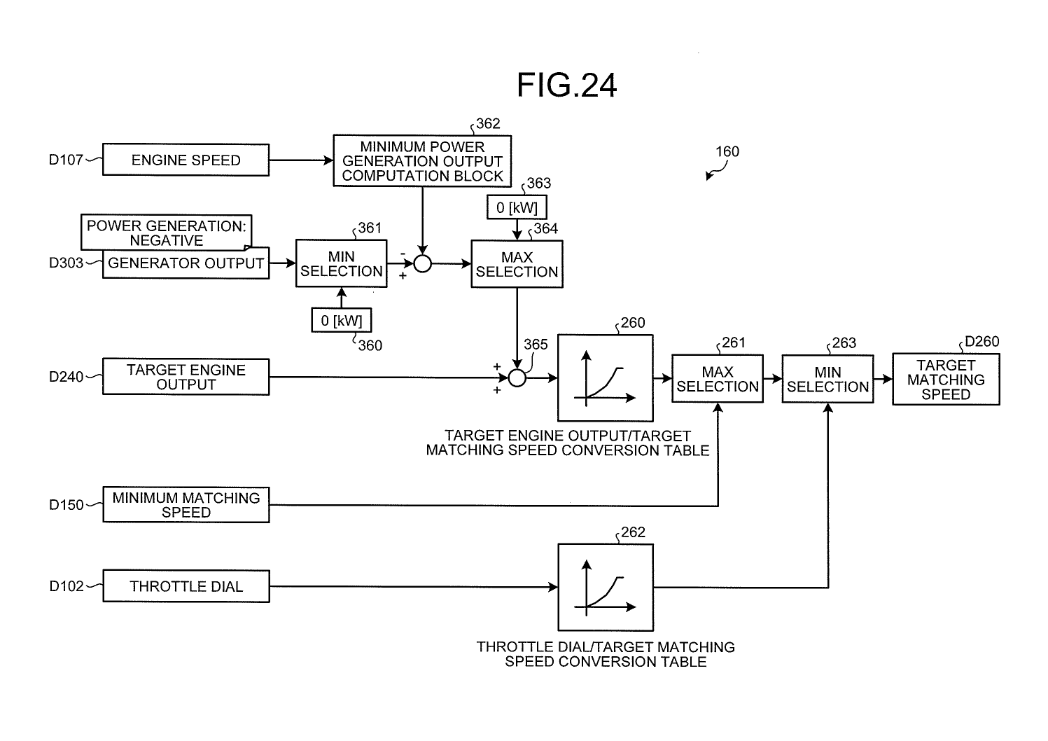

FIG. 24 illustrates a control flow of the target matching speed computation block 160 in the second embodiment, which corresponds to FIG. 11. Firstly, the target matching speed D260 is basically a speed at an intersection point of the target engine output and the target matching route ML. However, the maximum engine output D230 is a value that the fan horsepower and the generator output are added to the pump output limit value as illustrated in FIG. 22 to decide the target engine output D240 using the maximum engine output D230 as illustrated in FIG. 9. Furthermore, as illustrated in FIG. 24, the target engine output D240 is inputted into the target matching speed computation block 160 to decide the target matching speed D260. Moreover, the value of the target matching speed D260 varies according to the generator output D303 required of the generator 19.

Here, if the generator 19 generates electric power with small power generation torque, efficiency is not good. Consequently, if the generator 19 generates electric power, control is performed to generate electric power with preset minimum power generation torque or more. As a result, upon switching from a state where the generator 19 does not generate electric power (power generation OFF) to a state of generating electric power (power generation ON), ON and OFF of power generation is switched with minimum power generation torque as the boundary. Accordingly, the generator output changes discontinuously. In short, a matching point is determined at the intersection point of the target engine output D240 and the target matching route ML; accordingly the target matching speed D260 fluctuates greatly due to the switching of power generation ON/OFF in accordance with discontinuous changes in the generator output D303.

Consequently, if a minimum power generation output computation block 362 uses the engine speed D107 to compute the following equation:

Minimum power generation output (kW)=2π÷60×engine speed×minimum power generation torque (set value whose value is negative)÷1000

and obtains minimum power generation output, and the required generator output is lower than the obtained minimum power generation output, the target matching speed computation block 160 causes an addition unit 365 to add to the target engine output an output equal to a shortage of the minimum power generation output, uses the added target engine output to carry out a computation as a candidate value of the target matching speed with the target engine output/target matching speed conversion table 260, and prevents fluctuations in speed caused by power generation ON/OFF. A minimum value selection unit (MIN selection) 361 in the latter stage of the generator output D303 makes a comparison with the zero value 360 to output zero if there is no required generator output (such as if the output of the engine 17 is assisted). Therefore, nothing is added to the target engine output D240. Moreover, with respect to a maximum value selection unit (MAX selection) 364, if the required generator output is equal to the minimum power generation output or more, there is no shortage of the minimum power generation output. Accordingly, addition to the target engine output D240 is unnecessary. Hence, a negative value is inputted into the maximum value selection unit 364, zero being a maximum value is selected in comparison with a zero value 363, and the maximum value selection unit 364 outputs zero.

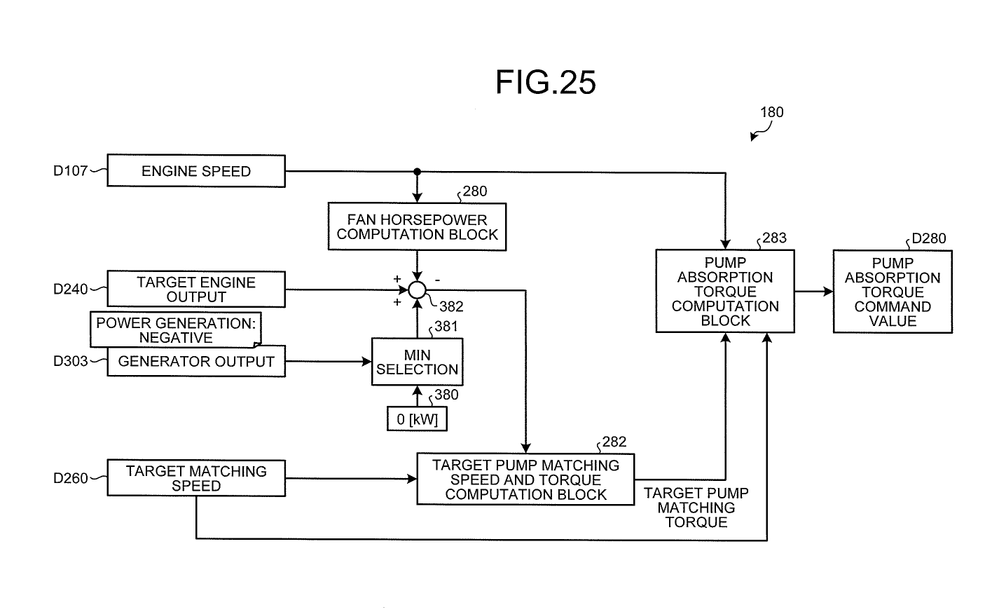

FIG. 25 illustrates a control flow of the pump absorption torque command value computation block 180 in the second embodiment, which corresponds to FIG. 13. In this case, output that not only the fan horsepower but the generator output D303 is subtracted from the target engine output D240 (target pump absorption horsepower) is outputted to the target pump matching speed and torque computation block 282. A plus or minus of the value of the required generator output is negative. Accordingly, a minimum value is selected by a minimum value selection unit (MIN selection) 381 in comparison with a zero value 380, and the selected value is added by a computation unit 382 to the target engine output D240, which results in the generator output D303 being practically subtracted from the target engine output D240.

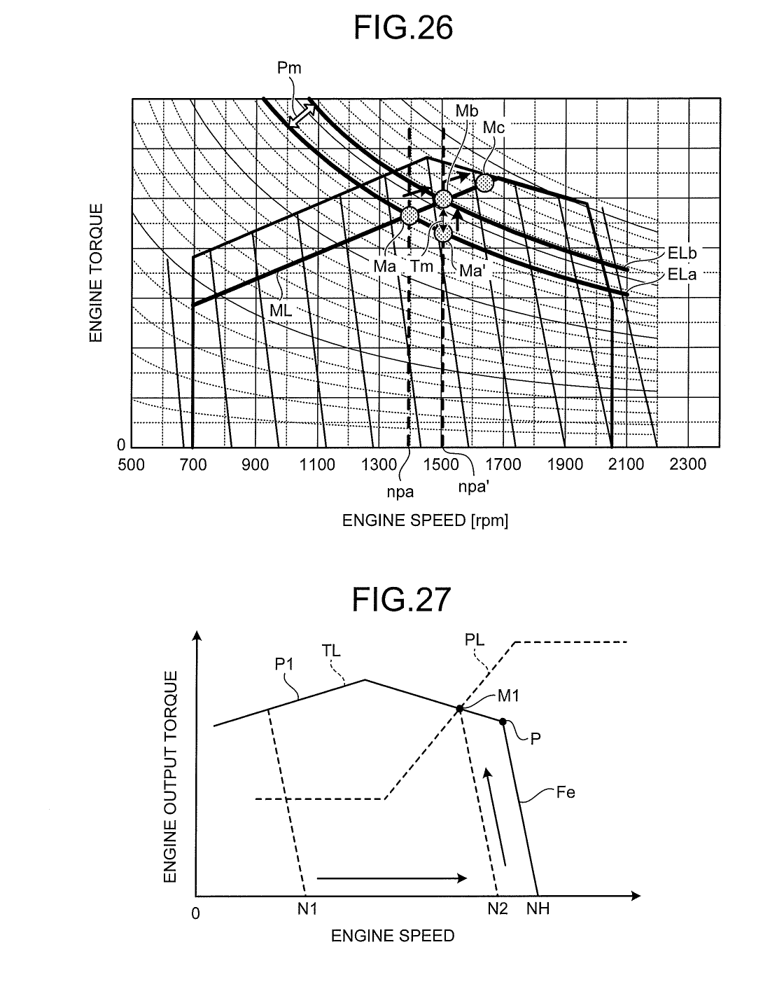

Here, as illustrated in FIG. 26, in a case of power generation OFF, an intersection point of an engine output command value curve ELa representing the target engine output D240 in the case of power generation OFF and the target matching route ML becomes a target matching point Ma, and at this point, the target matching speed D260 computed by the target matching speed computation block 160 becomes a target matching speed npa. Moreover, if electric power is generated with minimum power generation output Pm, an engine output command value curve ELb represents the target engine output D240 for satisfying the minimum power generation output Pm. An intersection point of the engine output command value curve ELb and the target matching route ML becomes a target matching point Mb, which leads to a target matching speed npa′ at this point.

If the engine control illustrated in FIG. 24 is not performed, the actual power generation output is low in the case of power generation with less than the minimum power generation output Pm. Accordingly, shifts are frequently made between the target matching points Ma and Mb by power generation ON/OFF, and the target matching speed also changes frequently at that point. In the second embodiment, if electric power is generated with less than the minimum power generation output Pm, the target matching speed is preset to npa′ at the time of power generation OFF. Therefore, there is no fluctuation in the target matching speed due to power generation ON/OFF. The target matching point at the time of power generation OFF becomes an intersection point Ma′ of the engine output command value curve ELa and the target matching speed npa′. Therefore, if the engine control illustrated in FIG. 24 is not performed, the matching point shifts from Ma to Mc through Mb with increase in generator output. However, in the second embodiment, the matching point shifts from Ma′ to Mc through Mb with increase in generator output, and there is no fluctuation in the target matching speed in a case of generator output to the extent that power generation is switched between ON and OFF. As a result, the operator of the hybrid excavator 1 does not feel uncomfortable.

### REFERENCE SIGNS LIST

1 Excavator, hybrid excavator
2 Vehicle base machine
3 Work equipment
4 Undercarriage
5 Upper structure
11 Boom
12 Arm
13 Bucket
14 Boom cylinder
15 Arm cylinder
16 Bucket cylinder
17 Engine
18 Hydraulic pump
18a Swash plate angle sensor
19 Generator
20 Control valve
20a Pump pressure detection unit
21 Travel motor
22 Capacitor
23 Inverter
23a Hybrid controller
24 Swing motor
25 Speed sensor
26 Operation lever
27 Level operation amount detection unit
28 Fuel adjustment dial
29 Mode switch unit
30 Engine controller
31 Swing hydraulic motor
32 Common rail control unit
33 Pump controller

1. An engine control device of a working machine, comprising:
a detection unit for detecting an operating state of the working machine;
a no-load maximum speed computation unit for computing a no-load maximum speed being an engine speed to be increased to the maximum upon a load of the working machine being released, based on the operating state;
a target matching speed computation unit for computing a target matching speed being an engine speed to be increased upon a load being applied, separately from the no-load maximum speed, based on the operating state;
a target engine output computation unit for computing target engine output that can be outputted to the maximum, based on the operating state; and
an engine control unit for controlling the engine speed between the no-load maximum speed and the target matching speed under a restriction of the target engine output.

2. The engine control device according to claim 1, further comprising:
a fluctuation range setting unit for presetting a range of fluctuations in engine speed; and
a minimum matching speed computation unit for setting an engine speed reduced by an engine speed equal to the range of fluctuations from the no-load maximum speed as a minimum speed limit value, and computing a minimum matching speed being an engine speed to be increased at the minimum upon a load being applied, based on the operating state, wherein
the engine control unit controls the engine speed between the no-load maximum speed and the minimum matching speed under the restriction of the target engine output.

3. The engine control device according to claim 1, wherein the engine control unit outputs an engine speed that a lower limit speed offset value is added to the target matching speed as an engine speed command value.

4. The engine control device according to claim 1, further comprising:
a variable displacement hydraulic pump; and
a capacity detection unit for detecting pump capacity of the variable displacement hydraulic pump, wherein
the engine control unit increases the engine speed upon the pump capacity being equal to a threshold value or more, and outputs an engine speed command value that the engine speed is reduced upon the pump capacity being less than the threshold value.

5. The engine control device according to claim 2, wherein the minimum matching speed computation unit increases the minimum matching speed upon a detected value by speed detection unit for detecting a speed of a rotating structure of the working machine being close to zero, sets a value that the minimum matching speed is reduced as a minimum speed limit value with increase in the detected value by the speed detection unit, and computes the minimum matching speed being an engine speed to be increased at the minimum upon a load being applied to the work equipment, based on the operating state.

6. A method for controlling an engine of a working machine, comprising:
detecting an operating state of the working machine;
computing a no-load maximum speed being an engine speed to be increased to the maximum upon a load of the working machine being released, based on the operating state;
computing a target matching speed being an engine speed to be increased upon a load being applied to the working machine, separately from the no-load maximum speed, based on the operating state;
computing target engine output that can be outputted to the maximum, based on the operating state; and
controlling the engine speed between the no-load maximum speed and the target matching speed under a restriction of the target engine output.

7. The method according to claim 6, further comprising:
presetting a range of fluctuations in engine speed; and
setting an engine speed reduced by an engine speed equal to the range of fluctuations from the no-load maximum speed as a minimum speed limit value, and computing a minimum matching speed being an engine speed to be increased at the minimum upon a load being applied to the working machine, based on the operating state, wherein
the controlling the engine controls the engine speed between the no-load maximum speed and the minimum matching speed under the restriction of the target engine output.
